(19) United States
(12) Patent Application Publication
(10) Pub. No.: US 2010/0220304 A1
(43) Pub. Date: Sep. 2, 2010

(54) MASK CASE, TRANSPORT APPARATUS, EXPOSURE APPARATUS, MASK TRANSPORT METHOD, AND DEVICE PRODUCTION METHOD

(76) Inventors: Mikihito Mukai, Yokohama-shi (JP); Bungo Suita, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/780,691

(22) Filed: May 14, 2010

Related U.S. Application Data
(63) Continuation of application No. PCT/JP2008/070585, filed on Nov. 12, 2008.

(30) Foreign Application Priority Data
Nov. 15, 2007 (JP) 2007-296640

(51) Int. Cl. G03B 27/42; G03B 27/58

(52) U.S. Cl. 355/53; 355/74

(57) ABSTRACT

A mask case which accommodates a mask therein includes a reinforcing member which has a strength corresponding to a load of the mask and which is provided at a contact portion contacting with a transporting vehicle and a transporting apparatus each of which is an external apparatus on which the mask case is placed. Each of the transporting vehicle and the transporting apparatus transporting the mask includes a plurality of ball transfers which support the reinforcing member of the mask case accommodating the mask therein and which serve as a case support portion suppressing friction which is generated with respect to the reinforcing member.

### CROSS-REFERENCES TO RELATED APPLICATIONS

This application is a Continuation Application of International Application No. PCT/JP2008/070585 which was filed on Nov. 12, 2008 claiming the conventional priority of Japanese patent Application No. 2007-296640 filed on Nov. 15, 2007.

### BACKGROUND OF THE INVENTION

1. Field of the Invention

The present invention relates to a mask case which accommodates a mask therein, a transport apparatus which transports the mask accommodated in the mask case, an exposure apparatus, a mask transport method, and a device production method.

2. Description of the Related Art

Conventionally, a mask is transported to a position in the vicinity of an exposure apparatus by an unmanned (automated) transport vehicle in a state that the mask is accommodated in a mask case. The mask is delivered to the exposure apparatus at a predetermined position while being accommodated in the mask case, for example, by a transport arm provided on the unmanned transport vehicle. The mask, which is placed at the predetermined position, is transported to a mask library by a transport arm provided on a transport apparatus in the exposure apparatus while being accommodated in the mask case, and the mask is stored (see Japanese Patent Application Laid-open No. 2005-243770).

### SUMMARY OF THE INVENTION

In recent years, the mask for producing a liquid crystal display device is conspicuously large-sized. In accordance to this, the weight of the mask is increased as well. It becomes difficult to transport such a mask by the transport arm, for example, in view of the strength of the transport arm to be secured.

An object of aspects of the present invention is to provide a mask case which makes it possible to reliably transport a mask having a large weight, a transport apparatus, an exposure apparatus, a mask transport method, and a device production method.

According to a first aspect of the present invention, there is provided a mask case which accommodates a mask therein, the mask case comprising a reinforcing member which has a strength corresponding to a load of the mask and which is provided at a contact portion contacting with an external apparatus on which the mask case is placed.

According to a second aspect of the present invention, there is provided a transport apparatus which transports a mask, the transport apparatus comprising a case support portion supporting the reinforcing member of the mask case according to the first aspect of the present invention, in which the mask is accommodated, and suppressing friction which is generated with respect to the reinforcing member.

According to a third aspect of the present invention, there is provided an exposure apparatus comprising the transport apparatus according to the second aspect of the present invention; and a projection optical system which forms, on a photosensitive substrate, a projected image of a pattern provided on a mask transported by using the transport apparatus.

According to a fourth aspect of the present invention, there is provided a mask transport method comprising transporting, by a first transport apparatus according to the second aspect of the present invention, a mask accommodated in the mask case according to the first aspect of the present invention to a second transport apparatus according to the second aspect of the present invention; slidably moving the mask case from a position on the case support portion of the first transport apparatus to a position on the case support portion of the lifting movement mechanism provided on the second transport apparatus; upwardly moving the case support portion of the lifting movement mechanism to a height of the storage section having the case support portion; and slidably moving the mask case from the position on the case support portion of the lifting movement mechanism to a position on the case support portion of the storage section.

According to a fifth aspect of the present invention, there is provided a mask transport method comprising transporting a mask accommodated in the mask case according to the first aspect of the present invention to the transport apparatus according to the second aspect of the present invention by a transport vehicle; delivering the mask case from the transport vehicle to a position on the case support portion of the delivery section provided on the transport apparatus; slidably moving the mask case from a position on the case support portion of the delivery section to a position on the case support portion of the lifting movement mechanism provided on the transport apparatus; upwardly moving the case support portion of the lifting movement mechanism to a height of the storage section having the case support portion; and slidably moving the mask case from a position on the case support portion of the lifting movement mechanism to a position on the case support portion of the storage section.

According to a sixth aspect of the present invention, there is provided a device production method comprising performing exposure by transferring a projected image of a pattern provided on a mask to a photosensitive substrate by using the exposure apparatus according to the third aspect of the present invention; developing the photosensitive substrate to which the projected image has been transferred to form a mask layer, having a shape corresponding to the projected image, on the photosensitive substrate; and processing the photosensitive substrate via the mask layer.

According to a seventh aspect of the present invention, there is provided a device production method comprising performing exposure by transferring a projected image of a pattern provided on a mask which is transported by the mask transport method according to the fourth aspect of the present invention, to a photosensitive substrate; developing the photosensitive substrate to which the projected image has been transferred to form a mask layer having a shape corresponding to the projected image on the photosensitive substrate; and processing the photosensitive substrate via the mask layer.

According to a eighth aspect of the present invention, there is provided a device production method comprising performing exposure by transferring a projected image of a pattern provided on a mask which is transported by the mask transport method according to the fifth aspect of the present invention, to a photosensitive substrate; developing the photosensitive substrate to which the projected image has been transferred to form a mask layer having a shape corresponding to the projected image on the photosensitive substrate; and processing the photosensitive substrate via the mask layer.

According to the aspects of the present invention, it is possible to reliably transport the mask having a large weight.

### BRIEF DESCRIPTION OF THE DRAWINGS

FIG. 1 shows a perspective view illustrating a schematic construction of an exposure apparatus according to a first embodiment.

FIG. 2 (FIGS. 2A to 2C) shows a construction of a mask case according to the first embodiment.

FIG. 3 shows a front view illustrating a construction of a transport vehicle according to the first embodiment.

FIG. 4 shows a plan view illustrating the construction of the transport vehicle according to the first embodiment.

FIG. 5 shows a plan view illustrating a construction of a transport apparatus according to the first embodiment.

FIG. 6 shows the construction of the transport apparatus according to the first embodiment.

FIG. 7 shows a construction of a mask library according to the first embodiment.

FIG. 8 shows a flow chart illustrating a transport procedure for the mask case according to the first embodiment.

FIG. 9 shows a state that the transport vehicle according to the first embodiment enters or advances into an exposure chamber.

FIG. 10 shows the state that the transport vehicle according to the first embodiment enters or advances into the exposure chamber.

FIG. 11 illustrates the sliding movement of the mask case from the transport vehicle to the transport apparatus, according to the first embodiment.

FIG. 12 illustrates the sliding movement of the mask case from the transport vehicle to the transport apparatus, according to the first embodiment.

FIG. 13 shows a state that the mask case is accommodated in an accommodating section of the mask library according to the first embodiment.

FIG. 14 illustrates adjustment of a load/unload direction of the mask case on the transport vehicle when the mask case is delivered from the transport vehicle to the transport apparatus, according to the first embodiment.

FIG. 15 shows a modification of a temporary fixation mechanism for the mask case in relation to the transport vehicle according to the first embodiment.

FIG. 16 shows a construction of a mask case delivery section provided for an exposure apparatus according to a second embodiment.

FIG. 17 shows a flow chart illustrating a transport procedure for a mask case according to the second embodiment.

FIG. 18 illustrates the delivery of the mask case from a transport apparatus according to the second embodiment to the mask case delivery section.

FIG. 19 shows a perspective view illustrating a construction of a mask case according to a third embodiment.

FIG. 20 shows a construction of a mask case delivery section provided for an exposure apparatus according to the third embodiment.

FIG. 21 shows a flow chart illustrating a transport procedure for the mask case according to the third embodiment.

FIG. 22 shows a construction of a carrier according to the third embodiment.

FIG. 23 shows a construction of a hand pawl (pawl grip) of the carrier according to the third embodiment.

FIG. 24 shows a flow chart illustrating a method for producing a semiconductor device by using the exposure apparatus according to the present invention.

FIG. 25 shows a flow chart illustrating a method for producing a liquid crystal display device by using the exposure apparatus according to the present invention.

### DESCRIPTION OF THE PREFERRED EMBODIMENTS

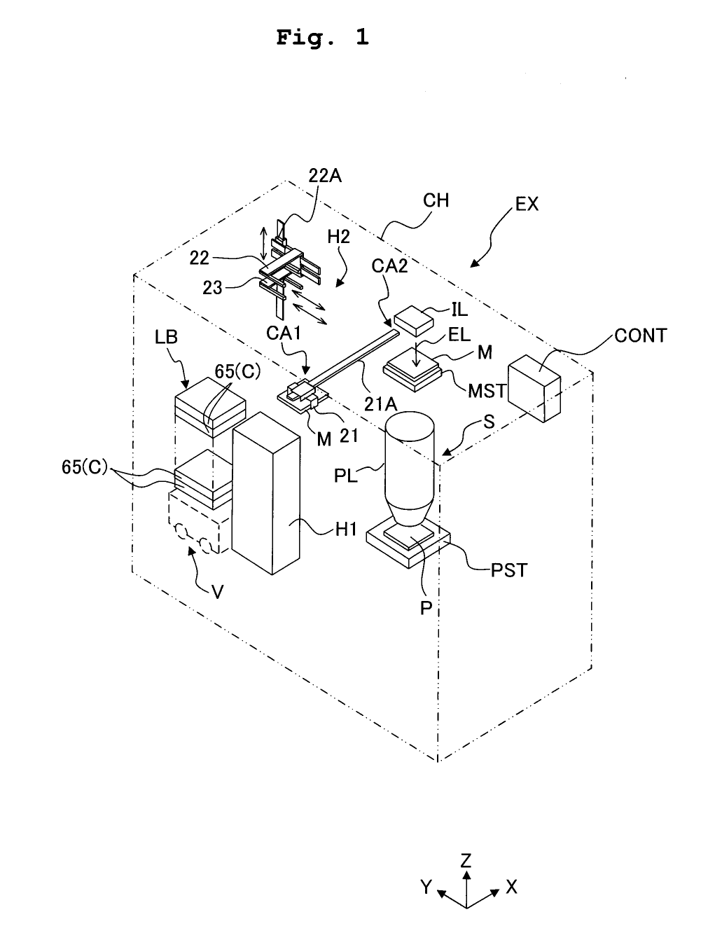

An explanation will be made below with reference to the drawings about a mask case, a transport apparatus, an exposure apparatus, a mask transport method, and a device production method according to the present invention. FIG. 1 shows a schematic construction of an exposure apparatus EX according to a first embodiment. In the following description, it is assumed that the X axis direction extends in a predetermined direction in a horizontal plane, the Y axis direction extends in a direction perpendicular to the X axis direction in the horizontal plane, and the Z axis direction extends in a direction which is perpendicular to the X axis and Y axis directions (i.e., the vertical direction).

The exposure apparatus EX includes an exposure section S which exposes a photosensitive substrate P with a pattern of a mask M, a mask library LB functioning as a storage section for storing mask cases C in which the masks M having large weights are accommodated, a transport apparatus H1 which transports the mask case C with respect to the mask library LB, and a transport apparatus H2 which transports the mask M taken out from the mask case C to the exposure section S. The exposure section S, the mask library LB, and the transport apparatuses H1, H2 are accommodated in an exposure chamber CH which is set to provide a predetermined environment. The operation of the entire exposure apparatus EX including the transport apparatuses H1, H2 is controlled by a controller CONT.

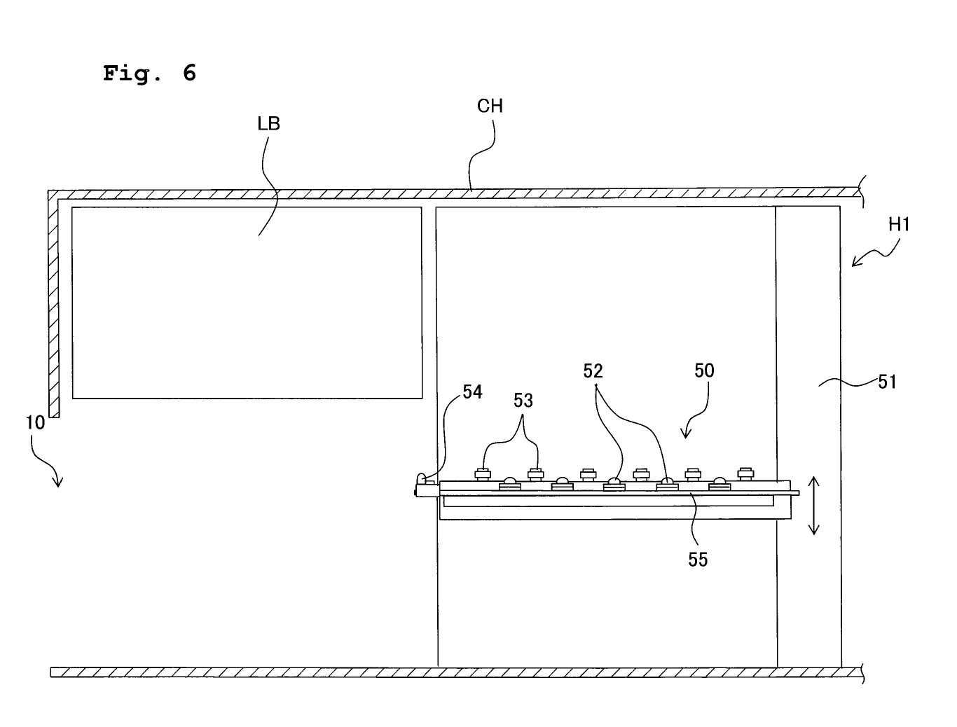

The mask library LB has a plurality of accommodating sections 65 which are provided over or above a load/unload port 10 (see FIG. 6) for the mask case C provided on the exposure chamber CH and which accommodate the mask cases C. The plurality of accommodating sections 65 are provided in the Z axis direction. The masks M are individually accommodated one by one in the mask cases C accommodated in the accommodating sections 65.

The exposure section S includes a mask stage MST which supports the mask M provided with the pattern, a substrate stage PST which supports the photosensitive substrate P as the objective of the exposure process, an illumination optical system IL which illuminates the mask M supported by the mask stage MST with an exposure light (exposure light beam) EL, and a projection optical system PL which forms a projected image of the pattern of the mask M, illuminated with an exposure light EL, on the photosensitive substrate P.

The mask M is transported by a transport vehicle V from an unillustrated mask stocker to the exposure apparatus EX in a state that the mask M is accommodated in the mask case C. The transport vehicle V enters or advances into the chamber CH from the load/unload port 10, and the transport vehicle V stops under or below the mask library LB. The mask case C is delivered between the transport vehicle V and the transport apparatus H1.

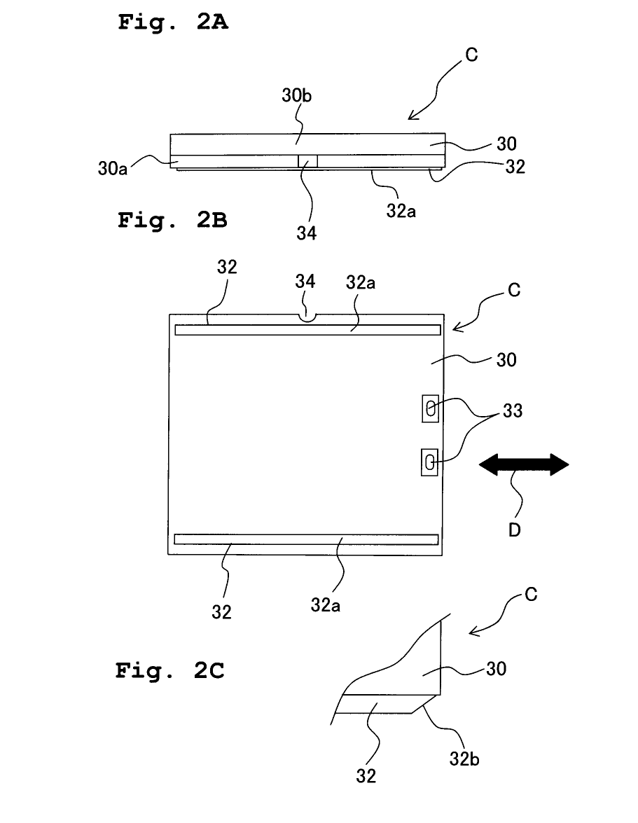

FIG. 2 (FIGS. 2A to 2C) shows the construction of the mask case C, wherein FIG. 2A shows a side view of the mask case C, FIG. 2B shows a bottom view of the mask case C, and FIG. 2C shows a magnified view of an end portion of a rail-shaped reinforcing member of the mask case C. As shown in FIG. 2, the mask case C includes a mask accommodating section (accommodating section body) 30 in which the mask M is accommodated, and a reinforcing member(s) 32 which is provided at a contact portion with respect to, for example, the transport apparatus H1, the transport vehicle V, etc. (hereinafter referred to as “external apparatus”) on which the mask case C is placed.

The mask accommodating section 30 is provided with a lower member 30a which has a rectangular shape as seen in a plan view and which forms a space for accommodating the mask M therein, and an upper member 30b which has a rectangular shape as seen in a plan view. The lower member 30a and the upper member 30b are formed by using, for example, aluminum in order to realize, for example, a light weight of the mask accommodating section 30. The reinforcing member 32 is provided to extend in a rail form in the mask case C at the both side portions of the bottom portion of the mask case C in a load/unload direction (direction of an arrow D shown in FIG. 2B) of the mask case C which is transported with respect to the external apparatus as described later on. The reinforcing member 32 is formed by using, for example, a hardened metal member (for example, hardened SUS400-based material); and the reinforcing member 32 has a strength corresponding to the load of the mask M accommodated in the accommodating section 30, i.e., the strength at which the reinforcing member 32 does not undergo, for example, the deformation by the load of the mask M. A constitutive material, which has a small specific gravity, is used for the mask accommodating section 30, and a constitutive material, which has a specific gravity larger than that of the constitutive material of the mask accommodating section 30, is used for the reinforcing member 32 in order to secure the load bearing strength of the reinforcing member 32 while realizing the mask case C having a light weight.

A flat surface portion 32a, which has a width of not less than a predetermined width with respect to the load/unload direction of the mask case C, is provided at the portion (contact portion) of the reinforcing member 32 contacting with the external apparatus. Further, as shown in FIG. 2C, a tapered surface 32b, which is inclined with respect to a direction of the load of the mask M, is provided on the reinforcing member 32 at each of the front end portion and the rear end portion in the load/unload direction. The reinforcing member 32 may be constructed of one member, or the reinforcing member 32 may be constructed by connecting two or more members. In particular, in a case that the reinforcing member 32 is constructed by connecting three or more members, it is preferable that spacing distances between the plurality of connecting positions are different from spacing distances between a plurality of contact points with respect to the external apparatus as described later on.

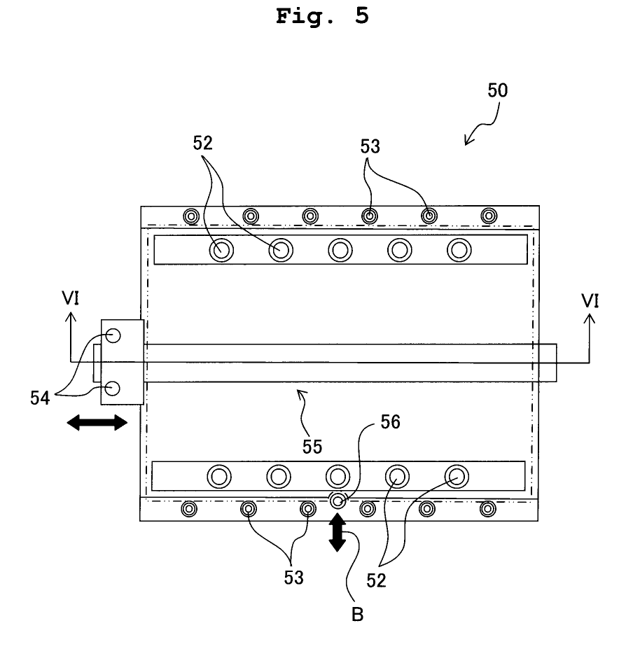

Connecting recesses 33, which function as connecting portions to be disconnectively connected to a slide mechanism 55 (see FIG. 5) provided on the transport apparatus H1 as described later on, are provided at a bottom surface portion of the mask case C. Further, a cutout 34, against which a cam follower 56 as a temporary fixation mechanism provided on the transport apparatus H1 as described later on is pushed to abut, is provided at a side surface portion of the mask case C.

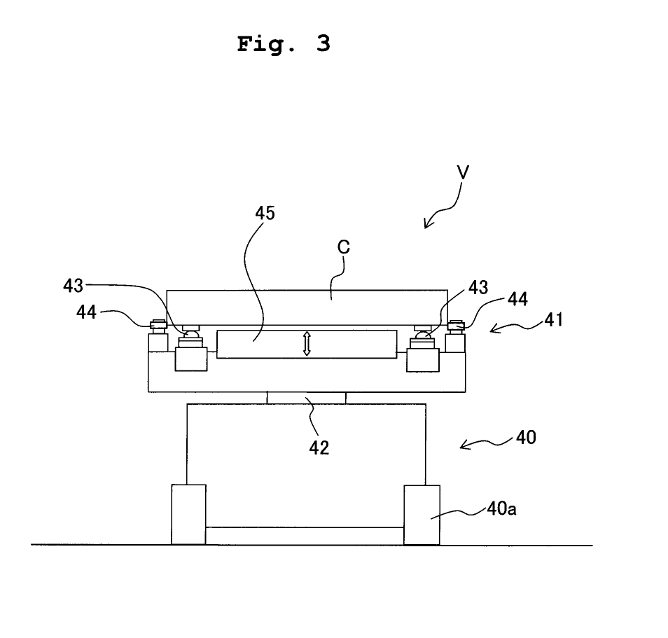

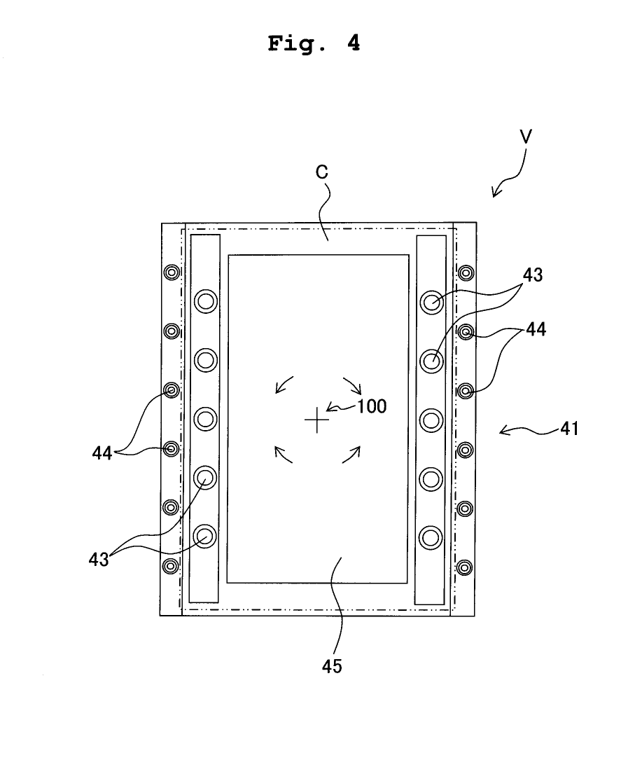

Next, an explanation will be made about the construction of the transport vehicle (transport apparatus) V with reference to FIGS. 3 and 4. FIG. 3 shows a front view of the transport vehicle V, and FIG. 4 shows a plan view of the transport vehicle V. The transport vehicle V includes a body section 40 which has wheels 40a functioning as an apparatus movement mechanism for moving the transport vehicle V and an unillustrated wheel driving section, a mask case transport section 41 which is provided on the body section 40, and a rotating mechanism 42 which rotates the mask case transport section 41 with respect to the body section 40, with a predetermined center of rotation 100 as the center of rotation.

The mask case transport section 41 is provided with a mechanism which holds the mask case C and which delivers the mask case C with respect to the transport apparatus H1. Specifically, ball transfers (ball transfer sections) 43, which functions as a case support portion for supporting the reinforcing member (reinforcing members) 32 of the mask case C and suppressing the friction which is generated with respect to the reinforcing members 32, are arranged in two substantially parallel arrays on the mask case transport section 41. The spacing distance between the two arrays is set to be approximately equal to the spacing distance between two pieces of the reinforcing member 32 provided on the mask case C. A plurality of cam followers 44, which function as a guide mechanism, are arranged, at side end portions on the mask case transport section 41, in two arrays substantially parallel to the arrays of the ball transfers 43 along with the arrays of the ball transfers 43. At least one array of the two arrays of the cam followers 44 are allowed to abut against a side surface portion of the mask case C and defines the load/unload direction (direction of the arrow D shown in FIG. 2B) of the mask case C with respect to the transport vehicle V.

A holding mechanism 45 is provided between the ball transfers 43 which are arranged in the two arrays on the mask case transport section 41. The holding mechanism 45 functions as a temporary fixation mechanism for holding the bottom surface portion of the mask case C and for temporarily fixing the position of the mask case C on the mask case transport section 41 by upwardly moving the mask case C to be separated with respect to the ball transfers 43.

The rotating mechanism 42 changes the load/unload direction of the mask case C of the transport vehicle V with respect to the body section 40 by rotating the mask case transport section 41 along the horizontal plane. In this case, the body section 40 is provided with an angle detecting device which detects angle information corresponding to an angle of rotation in the arrangement direction of the ball transfers 43 brought about by the rotating mechanism 42. The rotating mechanism 42 rotates the mask case transport section 41 and consequently the ball transfers 43 arranged in the two arrays, with the center of rotation 100 as the center of rotation, based on the angle information detected by the angle detecting device.

Next, an explanation will be made about the construction of the transport apparatus H1 with reference to FIGS. 5 and 6. FIG. 5 shows a plan view illustrating a mask case transport section in the transport apparatus H1, and FIG. 6 shows a side view illustrating the transport apparatus H1. In FIG. 6, the mask case transport section is shown as viewed along a line indicated by arrows VI-VI in FIG. 5. The transport apparatus H1 is provided with a mask case transport section 50 and a lifting driving section 51. The mask case transport section 50 and the lifting driving section 51 constitute the lifting movement mechanism.

The mask case transport section 50 is provided with a mechanism which holds the mask case C and which delivers the mask case C between the transport vehicle V and the mask library LB. Specifically, a plurality of ball transfers (ball transfer sections) 52, which function as case support portions supporting the reinforcing members 32 of the mask case C and suppressing the friction which is generated with respect to the reinforcing members 32, are arranged in two substantially parallel arrays on the mask case transport section 50. The spacing distance between the two arrays is set to be substantially equal to the spacing distance between the two reinforcing members 32 provided on the mask case C.

A plurality of cam followers 53, which function as a guide mechanism, are arranged in two arrays substantially parallel to the arrays of the ball transfers 52 at side end portions on the mask case transport section 50 along the arrays of the ball transfers 52. At least one array of the two arrays of the cam followers 53 is allowed to abut against the side surface portion of the mask case C to define the load/unload direction of the mask case C with respect to the transport apparatus H1.

A slide mechanism 55, which slidably moves the mask case C in the load/unload direction with respect to the ball transfers 52, is provided between the ball transfers 52 arranged in the two arrays on the mask case transport section 50. The slide mechanism 55 has connecting protrusions 54 which are connectable to the connecting recesses 33 of the mask case C. By moving the connecting protrusions 54 along the arrays of the cam followers 53, the mask case C is slidably moved in the load/unload direction on the ball transfers 52.

A cam follower 56, which functions as a temporary fixation mechanism for temporarily fixing the position of the mask case C with respect to the mask case transport section 50, is provided at one of end portions, of the mask case transport section 50, disposed along the arrays of the ball transfers 52. The cam follower 56 is driven, for example, by an unillustrated air cylinder in a direction (direction of an arrow B shown in FIG. 5) substantially perpendicular to the load/unload direction of the mask case C. Accordingly, the cam follower 56 is pushed to abut against the cutout 34 provided on one side surface portion of the mask case C. The other side surface portion of the mask case C is pushed to abut against the cam followers 53, and the position of the mask case C is temporarily fixed on the mask case transport section 50.

Here, the flat surface portions, each of which has the width of not less than the predetermined width with respect to the load/unload direction of the mask case C, are provided, as the contact surfaces with respect to the ball transfers 52, on the reinforcing members 32 provided for the mask case C. The flat surface portions are slidably moved on the ball transfers 52, and thus the mask case C is pushed to make the abutment by the cam follower 53.

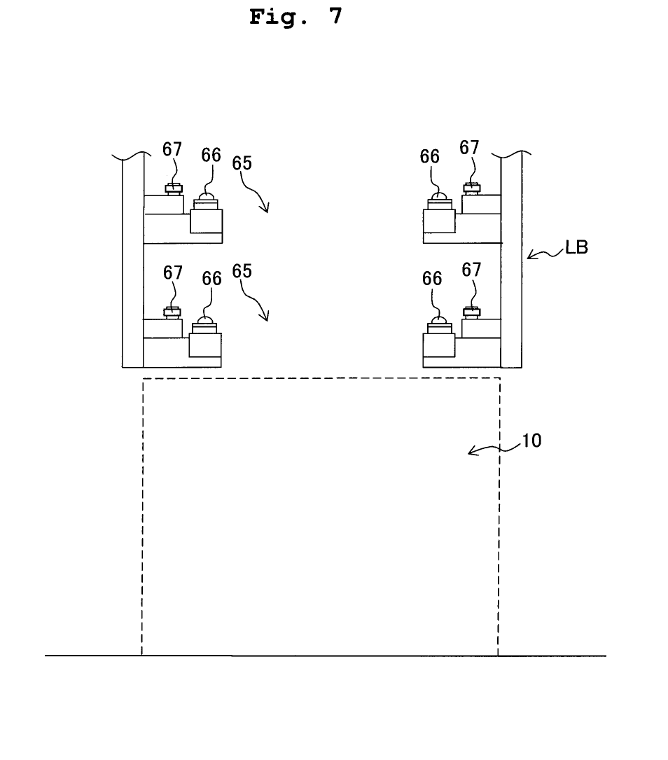

The lifting driving section 51 holds the mask case transport section 50 and vertically moves the mask case transport section 50 with respect to the height corresponding to the load/unload port 10 and the height corresponding to the mask library LB. In particular, the lifting driving section 51 allows the height of the ball transfers 43 of the transport vehicle V to substantially coincide with the height of the ball transfers 53 of the mask case transport section 50 at the height corresponding to the load/unload port 10. The lifting driving section 51 allows the height of the ball transfers 53 to substantially coincide with a height of ball transfers 66 (see FIG. 7) of the mask library LB, which will be described later on, at the height corresponding to the mask library LB.

Next, the construction of the mask library LB will be explained with reference to FIG. 7. FIG. 7 shows a view illustrating the mask library LB as seen in the direction of the load/unload port 10 for the mask case C. Each of the accommodating sections 65 of the mask library LB is provided with a mechanism which holds the mask case C and which delivers the mask case C with respect to the transport apparatus H1. Specifically, a plurality of ball transfers (ball transfer sections) 66, which function as case support portions supporting the reinforcing members 32 of the mask case C and suppressing the friction which is generated with respect to the reinforcing members 32, are arranged in two substantially parallel arrays for each of the accommodating sections 65. The spacing distance between the two arrays is set to be substantially equal to the spacing distance between the two reinforcing members 32 provided on the mask case C. A plurality of cam followers 67, which function as a guide mechanism, are arranged in two arrays substantially parallel to the arrays of the ball transfers 66 at side end portions of each of the accommodating sections 65 along the arrays of the ball transfers 66. At least one array of the two arrays of the cam followers 67 is allowed to abut against the side surface portion of the mask case C to define the load/unload direction of the mask case C with respect to the mask library LB.

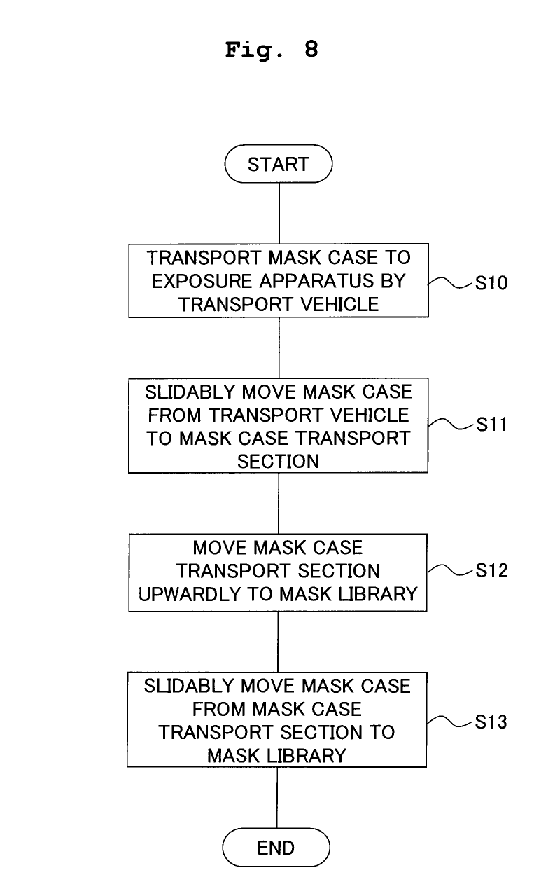

Next, an explanation will be made with reference to a flow chart shown in FIG. 8 about a loading procedure for transporting the mask M and the mask case C carried on the transport vehicle V to the mask library LB. An unloading procedure for transporting the mask M and the mask case C from the mask library LB to the transport vehicle V is performed by reversely performing the process of the loading procedure explained below.

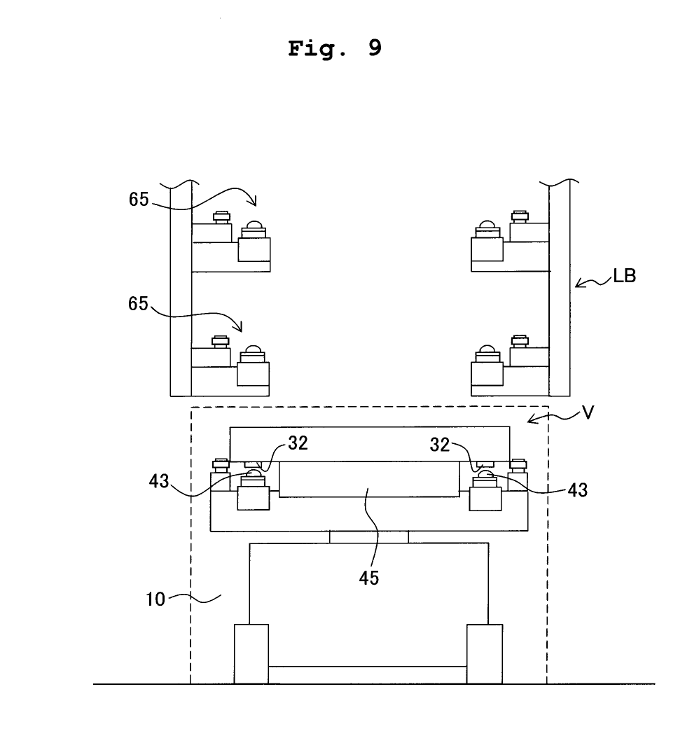

At first, the mask case C, in which the mask M is accommodated, is transported to the exposure apparatus EX by the transport vehicle V (Step S10). That is, the mask case C is transported to a position in the vicinity of the exposure chamber CH in the state that the mask case C is temporarily fixed by the holding mechanism 45 on the mask case transport section 41 of the transport vehicle V. In order to allow the transport vehicle V to enter or advance into the exposure chamber CH, the controller CONT opens the load/unload port 10 by an unillustrated opening/closing mechanism. As shown in FIG. 9, the transport vehicle V advances to a predetermined position under or below the mask library LB; and the transport vehicle V stops while being positioned with respect to the transport apparatus H1 by an unillustrated positioning mechanism provided for the transport vehicle V. At this point in time, the transport vehicle V upwardly moves the mask case C with respect to the ball transfers 43 by upwardly moving the holding mechanism 45 so that the ball transfers 43 and the reinforcing members 32 of the mask case C are separated from each other. However, after the transport vehicle V stops at the predetermined position, the holding mechanism 45 is moved downwardly in order to be prepared for the delivery of the mask case C to the transport apparatus H1. Accordingly, the mask case C is moved downwardly with respect to the ball transfers 43 to give a state that the reinforcing members 32 of the mask case C are supported by the ball transfers 43.

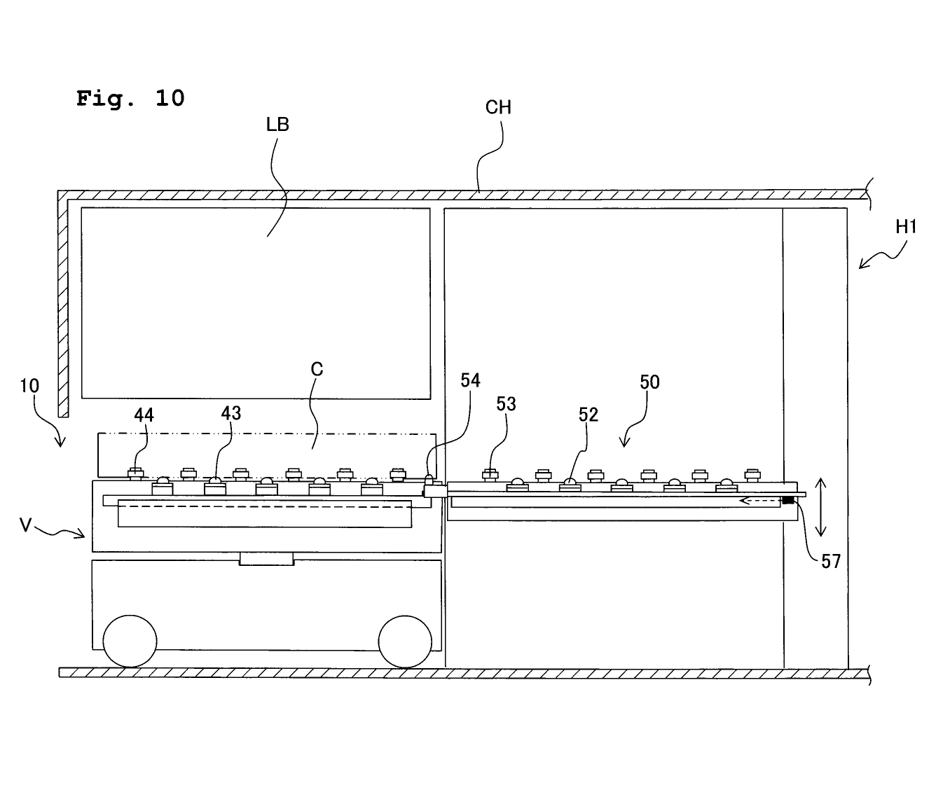

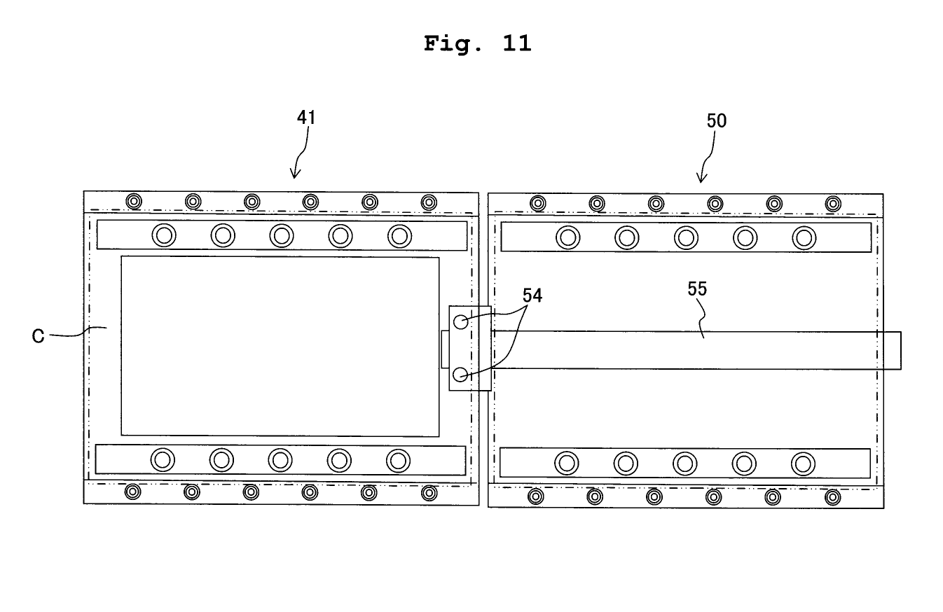

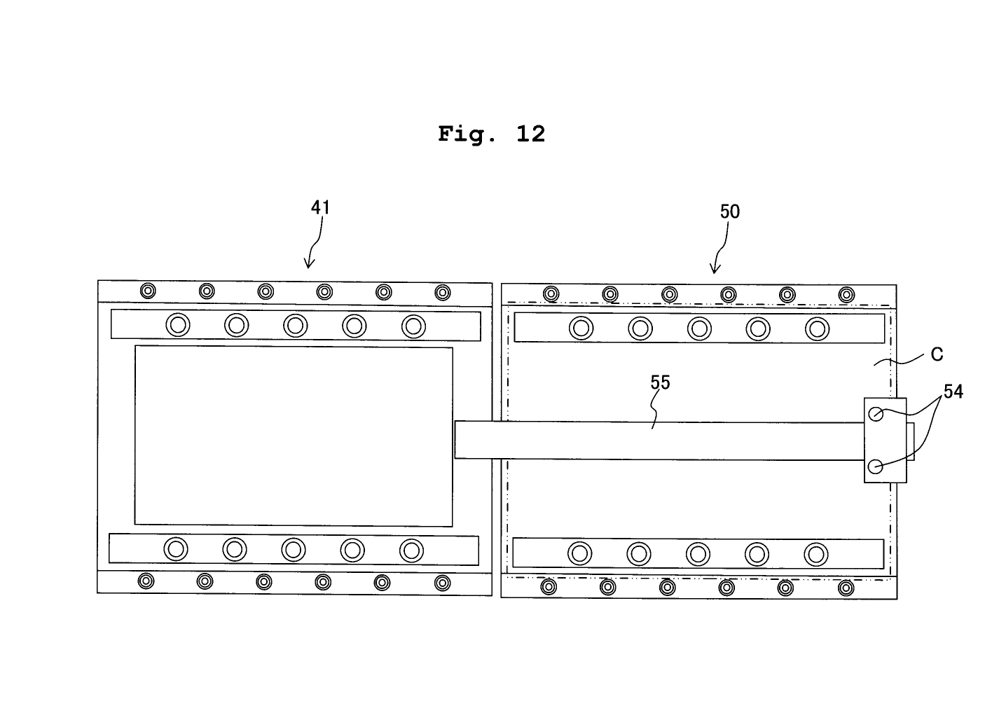

Subsequently, the mask case C is slidably moved from the transport vehicle V onto the mask case transport section 50 of the transport apparatus H1 (Step S11). That is, the controller CONT moves the mask case transport section 50 to the height (first transport height) corresponding to the load/unload port 10 by the lifting driving section 51 so that the height of the tops of the ball transfers 43 of the transport vehicle V is made to be coincident with the height of the tops of the ball transfers 52 of the mask case transport section 50. As shown in a side view of FIG. 10 and a plan view of FIG. 11, the controller CONT moves the connecting protrusions 54 of the slide mechanism 55 toward the transport vehicle V so that the connecting protrusions 54 are connected to the connecting recesses 33 of the mask case C. Whether or not the connecting protrusions 54 of the slide mechanism 55 and the connecting recesses 33 of the mask case C are normally connected to one another is detected, for example, by an optical sensor 57 (see FIG. 10) provided on the mask case transport section 50, depending on the presence or absence of a reflected light (reflected light beam) of a light (light beam) radiated to an unillustrated reflecting mirror provided at a lower portion of the connecting protrusion 54. As shown in FIG. 12, the controller CONT moves the connecting protrusions 54 to positions on the side opposite to the transport vehicle V by the slide mechanism 55, to thereby slidably move the mask case C from the position on the ball transfers 43 of the transport vehicle V to the position on the ball transfers 52 of the mask case transport section 50. Accordingly, the mask case C is delivered from the transport vehicle V to the mask case transport section 50. As for the mask case C having been moved onto the mask case transport section 50, the position is temporarily fixed on the mask case transport section 50 by the cam follower 56.

The phrase “the height of the ball transfers 43 is made to be coincident with the height of the ball transfers 52 at the height corresponding to the load/unload port 10” includes not only a case in which the height of the ball transfers 43 is made to be strictly coincident with the height of the ball transfers 52 but includes also a case in which the height of the ball transfers 43 is made to be approximately coincident with the height of the ball transfers 52. In this procedure, when the mask case C is delivered from the transport vehicle V to the mask case transport section 50, it is preferable that the ball transfers 52 are set at a position slightly higher than that of the ball transfers 43. When the mask case C is delivered reversely to the above, it is preferable that the ball transfers 43 are set at a position slightly higher than that of the ball transfers 52. The tapered surfaces 32b are provided at the forward end portions of the reinforcing members 32 possessed by the mask case C. Therefore, when the heights are set as described above, it is possible to deliver the mask case C without any shock between the ball transfers 43, 52.

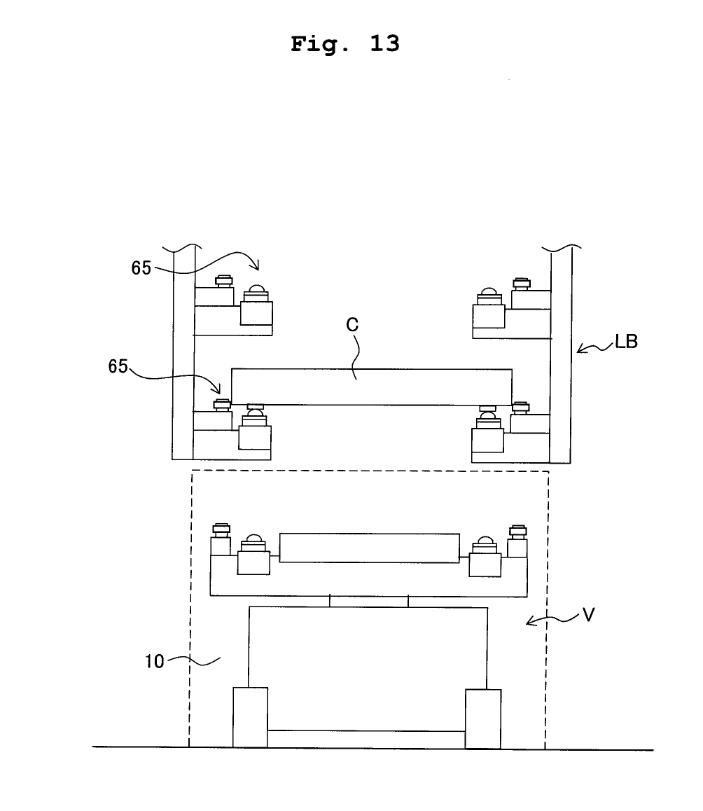

Subsequently, the controller CONT upwardly moves the mask case transport section 50 by the lifting driving section 51 to a height corresponding to the mask library LB, i.e., a height (second transport height) of an accommodating section 65 designated to accommodate the mask case C (Step S12). The height of the tops of the ball transfers 52 of the mask case transport section 50 is made to be coincident with the height of the tops of the ball transfers 66 of the designated accommodating section 65. The controller CONT releases the mask case C from the temporary fixation having been effected by the cam follower 56; and the controller CONT moves the connecting protrusions 54 to a position on the side of the accommodating section 65 by the slide mechanism 55, to thereby slidably move the mask case C from the position on the ball transfers 52 of the mask case transport section 50 to the position on the ball transfers 66 of the accommodating section 65. Thus, as shown in FIG. 13, the mask case C is delivered to the designated accommodating section 65 of the mask library LB (Step S13).

The accommodating section 65, to which the mask case C is to be delivered, is designated, for example, via a predetermined input device before the start of the loading of the mask case C. Alternatively, the transport apparatus H1 may be provided with a detecting device detecting the accommodating section 65 in which the mask case C is not accommodated, and the accommodating section 65, which is to be subjected to the delivery, can be appropriately designated based on a detection result of the detecting device.

The phrase “the height of the ball transfers 52 is made to be coincident with the height of the ball transfers 66 at the height corresponding to the mask library LB” includes not only a case in which the height of the ball transfers 52 is made to be strictly coincident with the height of the ball transfers 66 but includes also a case in which the height of the ball transfers 52 is made to be approximately coincident with the height of the ball transfers 66, in the same manner as the height relationship between the ball transfers 43 and the ball transfers 52 at the height corresponding to the load/unload port 10.

In this procedure, the mask M is transported from the mask library LB to the exposure section S by the transport apparatus H2. That is, the mask case transport section 50 of the transport apparatus H1 is moved, under the control of the controller CONT, by the lifting driving section 51 to the height of the accommodating section 65 which accommodates the mask case C accommodated with the mask M designated to be used for the exposure process. The mask case C is slidably moved onto the mask case transport section 50 by the slide mechanism 55 of the transport apparatus H1 in the state that the height of the ball transfers 66 of the accommodating section 65 is made to be coincident with the height of the ball transfers 52 of the mask case transport section 50. In this procedure, the mask case C is slidably moved onto the mask case transport section 50 in such a state that the upper member 30b of the mask case C is allowed to remain in the accommodating section 65 of the mask library LB, and that the mask M is placed on the lower member 30a of the mask case C. The lifting driving section 51 upwardly moves the mask case transport section 50 of the transport apparatus H1 to a position CA1 (see FIG. 1) which is disposed at the uppermost portion of the transport apparatus H1.

The mask M is delivered to a carrier 21 at the position CA1. The carrier 21 is movable between the position CA1 and a position CA2 while being supported by a carrier guide section 21A. Further, the carrier 21 is movable in the Z axis direction together with the carrier guide section 21A. In other words, the carrier 21 is provided movably in the X axis and Z axis directions as shown in FIG. 1. The carrier 21 has a vacuum attraction hole disposed on the lower surface thereof such that the mask M can be subjected to the suction holding and that the mask M can be released from the holding in accordance with an ON/OFF operation of an unillustrated connected vacuum pump. The carrier 21 receives the mask M from an arm section 20 at the position CA1, and then the carrier 21 transports the mask M to the position CA2. The carrier 21, moved to the position CA2, delivers the mask M to a load arm 22 at the position CA2. In this case, the load arm 22 and an unload arm 23 are movable in the Y axis and Z axis directions as shown in FIG. 1. The load arm 22 and the unload arm 23 are individually movable in the Y axis direction between the position CA2 and the mask stage MST, and the load arm 22 and the unload arm 23 are integrally movable while being supported by a Z axis guide section 22A in relation to the Z axis direction. The load arm 22 and the unload arm 23 each have a vacuum attraction hole for holding the mask M such that the mask M is subjected to the suction holding, and that the mask M is released from the holding in accordance with an ON/OFF operation of a connected vacuum pump. The load arm 22 receives the mask M, which is to be used for the exposure process, from the carrier 21 at the position CA2 and transports the mask M to the mask stage MST. The mask M, which is supported by the mask stage MST, is illuminated with the exposure light EL by the illumination optical system IL. Accordingly, the projected image of the pattern provided on the mask M is transferred by the projection optical system PL onto the photosensitive substrate P supported by the substrate stage PST.

The mask M, for which the exposure process has been completed in the exposure section S, is unloaded from the mask stage MST by the unload arm 23, and the mask M is transported to the position CA2. The mask M, which has been transported to the position CA2, is delivered to the carrier 21 which is allowed to wait at this position. The mask M is transported to the position CA1 by the carrier 21. The mask M, which has been transported to the position CA1, is placed on the lower member 30a of the mask case disposed on the mask case transport section 50 of the transport apparatus H1 allowed to wait at the position CA1. The mask M is moved by the lifting driving section 51 to the height of the accommodating section 65 in which the mask M has been accommodated before the exposure process. The lower member 30a is slidably moved into the accommodating section 65 by the slide mechanism 55 of the transport apparatus H1 in the state that the height of the ball transfers 66 of the accommodating section 65 is made to be coincident with the height of the ball transfers 52 of the mask case transport section 50.

As explained above, according to the first embodiment, the mask case C is provided with the reinforcing members 32 which have the strength corresponding to the load of the mask M at the contact portions with respect to, for example, the transport apparatus H1 and the transport vehicle V as the external apparatus on which the mask case C is to be placed. The transport vehicle V and the transport apparatus H1 as the transport apparatuses and the mask library LB as the storage section are provided respectively with the plurality of ball transfers 43, 52, 66 as the case support portions which support the reinforcing members 32 of the mask case C and which suppress the friction generated with respect to the reinforcing members 32. Therefore, the mask case C, in which the mask M having the large weight is accommodated, can be transported reliably and smoothly by the transport vehicle V, the transport apparatus H1, and the mask library LB.

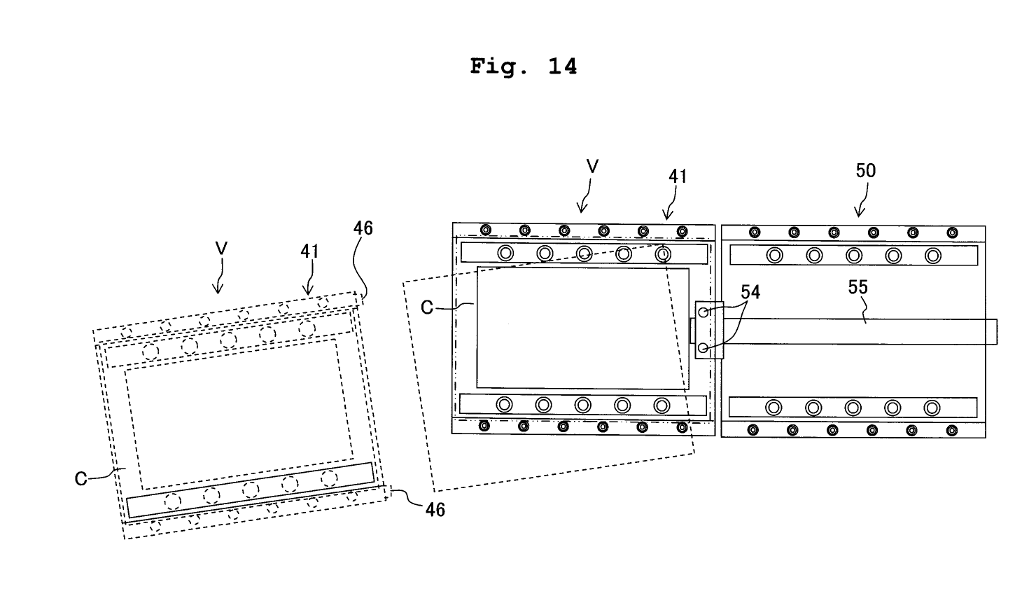

In the first embodiment described above, an angle sensor, which detects the posture or attitude of the transport vehicle V with respect to the transport apparatus H1, i.e., the angle of rotation of the mask case transport section 41 along the horizontal plane with respect to the transport apparatus H1, may be provided at a front portion of the transport vehicle V. It is allowable that the mask case transport section 41 is rotated by the rotating mechanism 42 based on a detection result obtained by the angle sensor so that the load/unload direction of the mask case C with respect to the transport apparatus H1 is made to be coincident with the load/unload direction of the mask case C with respect to the transport vehicle V as well. FIG. 14 shows a state that the transport vehicle V approaches the mask case transport section 50 of the transport apparatus H1. In FIG. 14, the transport vehicle V approaches the transport apparatus H1 in a state that the transport vehicle V has a predetermined angle with respect to the transport apparatus H1. The angle of rotation of the mask case transport section 41 with respect to the transport apparatus H1 is detected by angle sensors 46 provided at a front portion of the transport vehicle V; and the mask case transport section 41 is rotated by the rotating mechanism 42 based on an obtained detection result. Accordingly, when the transport vehicle V is moved to the position in the vicinity of the transport apparatus H1, the load/unload direction of the mask case C with respect to the transport apparatus H1 is made to be coincident with the load/unload direction of the mask case C with respect to the transport vehicle V. By adopting the construction as described above, even if the load/unload direction of the mask case C with respect to the transport apparatus H1 is deviated from the load/unload direction of the mask case C with respect to the transport vehicle V when the transport vehicle V approaches the transport apparatus H1, it is possible to assuredly make the load/unload direction of the mask case C with respect to the transport apparatus H1 to be coincident with the load/unload direction of the mask case C with respect to the transport vehicle V when the transport vehicle V is moved to the position in the vicinity of the transport apparatus H1. Therefore, the mask case C can be delivered smoothly and quickly between the transport vehicle V and the transport apparatus H1.

In the first embodiment described above, the holding mechanism 45, which holds the bottom surface portion of the mask case C and which upwardly/downwardly moves the mask case C with respect to the ball transfers 43, is provided as the temporary fixation mechanism for the mask case C on the mask case transport section 41. However, the temporary fixation mechanism may be constructed by using an upward/downward movement mechanism which upwardly/downwardly moves the mask case C together with the ball transfers 43 and a holding section which holds the mask case C moved downwardly by the upward/downward movement mechanism.

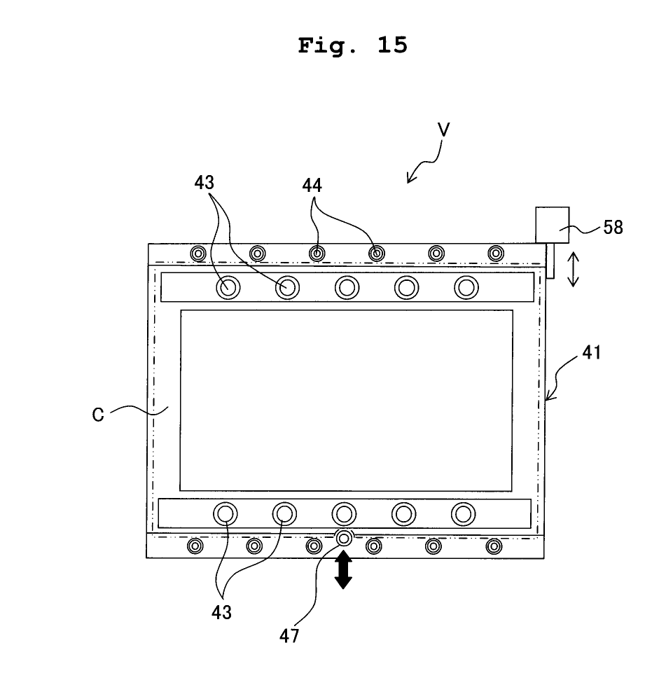

Further, as shown in FIG. 15, a cam follower 47, which functions as the temporary fixation mechanism for temporarily fixing the position of the mask case C with respect to the mask case transport section 41, may be provided at one end portion of the mask case transport section 41 along with the array of the ball transfers 43. The cam follower 47 is driven in a direction (direction of an arrow shown in FIG. 15) substantially perpendicular to the load/unload direction of the mask case C by, for example, an unillustrated air cylinder in the same manner as the cam follower 56 of the transport apparatus H1. Accordingly, the cam follower 47 is pushed to abut against the cutout 34 provided at one side surface portion of the mask case C, and the other side surface portion of the mask case C is pushed to abut against the cam followers 44, and the position of the mask case C is temporarily fixed on the mask case transport section 41.

A stopper mechanism 58 shown in FIG. 15 prevents the mask case C from sliding out from the mask case transport section 41 in any situation other than the situation in which the mask case C is delivered between the transport vehicle V and the transport apparatus H1. The stopper mechanism 58 is preferably provided for at least one of those including the transport apparatus H1 without being limited to the transport vehicle V.

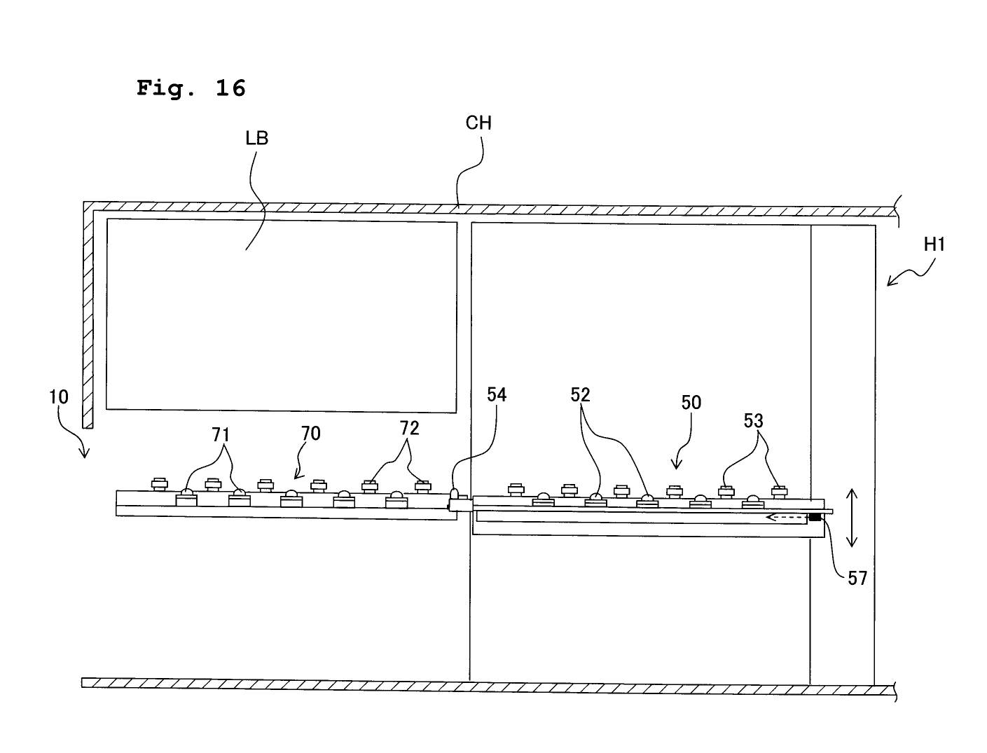

Next, an explanation will be made with reference to FIGS. 16 to 18 about an exposure apparatus according to a second embodiment of the present invention. In the exposure apparatus according to the first embodiment, the mask case is slidably moved directly from the transport vehicle to the transport apparatus. The exposure apparatus according to the second embodiment is constructed in the same manner as the exposure apparatus according to the first embodiment except that the mask case is delivered from a transport vehicle to a delivery section which is provided in the exposure chamber of the exposure apparatus, and then the mask case is slidably moved from the delivery section to the transport apparatus. Therefore, in the explanation of the second embodiment, the components or parts, which are constructed in the same manner as those of the exposure apparatus according to the first embodiment, are omitted from the detailed explanation, and the components or parts, which are constructed in the same manner as those of the exposure apparatus according to the first embodiment, will be explained by using the same reference numerals as those used in the first embodiment. The transport vehicle, which transports the mask case to the exposure apparatus, is also constructed differently from the transport vehicle of the first embodiment in conformity with the fact that the exposure apparatus according to the second embodiment is provided with the delivery section.

FIG. 16 shows a construction of a mask case delivery section 70 provided under or below the mask library LB of the exposure apparatus EX. The mask case delivery section 70 is provided with a mechanism which holds the mask case C and which delivers the mask case C with respect to the transport apparatus H1 in the same manner as the accommodating section 65 of the mask library LB. That is, the mask case delivery section 70 has substantially parallel two arrays of a plurality of ball transfers 71 which are arranged in the mask delivery section 70 and which function as case support portions for supporting the reinforcing members 32 of the mask case C and suppressing the friction generated with respect to the reinforcing members 32. The spacing distance between the two arrays is set to be substantially equal to the spacing distance between the two reinforcing members 32 provided on the mask case C.

A plurality of cam followers 72, which function as a guide mechanism, are arranged in two arrays substantially parallel to the arrays of the ball transfers 71 at side end portions of the mask case delivery section 70 along the arrays of the ball transfers 71 arranged in the two arrays. At least one array of the two arrays of the cam followers 72 is allowed to abut against the side surface portion of the mask case C to define the load/unload direction of the mask case C with respect to the mask case delivery section 70. FIG. 16 shows only the array of the ball transfers 71 and the array of the cam followers 72 positioned on the back side (far side) in the drawing, of the ball transfers 71 and the cam followers 72 provided in the two arrays respectively.

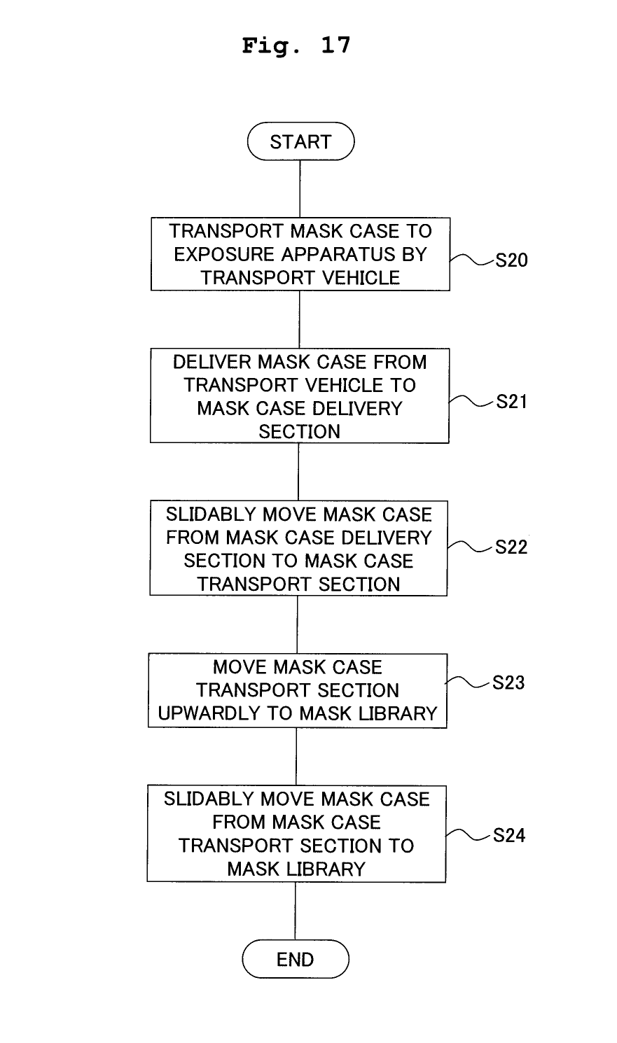

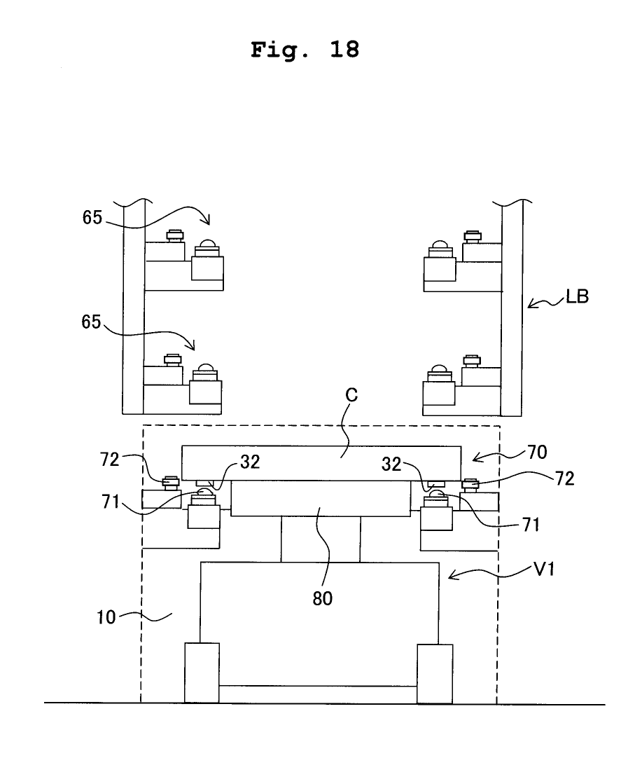

A flow chart shown in FIG. 17 illustrates the transport of the mask case C to the mask library LB of the exposure apparatus EX according to the second embodiment. At first, the mask case C, in which the mask M is accommodated, is transported to the exposure apparatus EX by a transport vehicle V1 (Step S20). In this case, as shown in FIG. 18, the transport vehicle V1 is provided with a mask case transport table 80 based on the construction of the transport vehicle V according to the first embodiment, instead of the mask case transport section 41. That is, the transport vehicle V1 does not have the ball transfers supporting the mask case C and the cam followers guiding the mask case C. In order to allow the transport vehicle V1 to enter or advance into the exposure chamber CH, the controller CONT opens the load/unload port 10 by an unillustrated opening/closing mechanism. As shown in FIG. 18, the transport vehicle V1 advances to a predetermined position under or below the mask library LB, and the transport vehicle V1 stops. At this point in time, the transport vehicle V1 is in such a state that the mask case transport table 80 is moved upwardly, and that the reinforcing members 32 of the mask case C are separated from the ball transfers 71.

Subsequently, the transport vehicle V1 moves the mask case transport table 80 downwardly to place the mask case C on the ball transfers 71 provided on the mask case delivery section 70 so that the mask case C is delivered to the mask case delivery section 70 (Step S21).

Subsequently, the mask case C is slidably moved from the mask case delivery section 70 onto the mask case transport section 50 of the transport apparatus H1 (Step S22). That is, the controller CONT moves the mask case transport section 50 to a height (first transport height) corresponding to the mask case delivery section 70 by the lifting driving section 51 so that the height of the tops of the ball transfers 71 of the mask case delivery section 70 is made to be coincident with the height of the tops of the ball transfers 52 of the mask case transport section 50. The controller CONT moves the connecting protrusions 54 of the slide mechanism 55 toward the mask case delivery section 70 so that the connecting protrusions 54 are connected to the connecting recesses 33 of the mask case C. Further, the controller CONT moves the connecting protrusions 54 to positions disposed on the side opposite to the mask case delivery section 70 by the slide mechanism 55, to thereby slidably move the mask case C from the position on the ball transfers 71 of the mask case delivery section 70 to the position on the ball transfers 52 of the mask case transport section 50. Accordingly, the mask case C is delivered from the mask case delivery section 70 to the mask case transport section 50. The phrase “the height of the ball transfers 71 is made to be coincident with the height of the ball transfers 52 at the height corresponding to the mask case delivery section 70” includes not only a case in which the height of the ball transfers 71 is made to be strictly coincident with the height of the ball transfers 52 but include also a case in which the height of the ball transfers 71 is made to be approximately coincident with the height of the ball transfers 52 in the same manner as the height relationship between the ball transfers 43 and the ball transfers 52 at the height corresponding to the load/unload port 10 in the first embodiment.

Subsequently, process (Steps S23, S24), in which the mask case C is transported from the transport apparatus H1 to the mask library LB, is performed in the same manner as Steps S12, S13 in the first embodiment. An unloading procedure for transporting the mask case C from the mask library LB to the mask case delivery section 70 is performed by reversely performing the process of the loading procedure in which the mask case C is transported from the mask case delivery section 70 to the mask library LB as explained below.

As explained above, according to the second embodiment, the mask case C is provided with the reinforcing members 32 in the same manner as in the first embodiment, and the mask case delivery section 70 and the mask case delivery section 50 of the transport apparatus H1 and the accommodating section 65 of the mask library LB are provided respectively with the ball transfers 71, 52, 66 as the case support portions for supporting the reinforcing members 32 of the mask case C and suppressing the friction which is generated with respect to the reinforcing members 32. Therefore, the mask case C, in which the mask M having the large weight is accommodated, can be transported reliably and smoothly by the transport vehicle V1, the transport apparatus H1, and the mask library LB. Further, the construction or structure of the transport vehicle V1 can be simplified as compared with the construction or structure of the transport vehicle V.

In the respective embodiments described above, the reinforcing members 32 are provided on the bottom surface portions of the mask case C. However, it is enough that the reinforcing member is provided at any portion making contact with the external apparatus. Therefore, for example, a protrusion may be provided on a side surface of the mask accommodating section of the mask case, and the reinforcing member may be provided on the lower surface of the protrusion to make contact with the external apparatus.

In the respective embodiments described above, the reinforcing members 32 are provided to extend in the rail form on the bottom surface portions of the mask case C. However, the reinforcing member may be provided in a flat plate form on the entire bottom surface portion of the mask case C. In this case, the spacing distances between the respective arrays of the ball transfers 43, 52, 66 provided in the two arrays for the transport vehicle V, the transport apparatus H1, and the mask library LB respectively can be arbitrarily set within a width of the flat plate-shaped reinforcing member. Further, the plurality of ball transfers 43, 52, 66 can be arranged two-dimensionally without being limited to the array form. By doing so, it is possible to transport any mask, which has a weight larger than that of the mask M, reliably and smoothly.

In the respective embodiments described above, when the mask case C is delivered between the mask case transport section 50 and the mask case transport section 41, the accommodating section 65 or the mask case delivery section 70, the slide mechanism 55 and the mask case C are connected to each other at the bottom surface portion of the mask case C. However, the connection may be performed, for example, at any side surface portion or any upper surface portion without being limited to the bottom surface portion of the mask case. Further, the connection between the slide mechanism 55 and the mask case C is not limited to the connection brought about by the engagement between the recess and the protrusion. The connection may be performed by using any connecting mechanism using, for example, a clamp mechanism, an electromagnet mechanism, or a vacuum attraction mechanism, etc.

In the respective embodiments described above, the ball transfers are used as the case support portions of the transport vehicle V, the transport apparatus H1, and the mask library LB. However, the present invention is not limited to this. It is also possible to use an air floating mechanism, a cam follower mechanism, a bearing mechanism, a roller conveyer mechanism, etc. That is, it is possible to use various mechanisms having the function to suppress the friction to be generated with respect to the reinforcing member when the mask case is supported via the reinforcing member.

In the respective embodiments described above, the plurality of ball transfers, which have the same structure, are used for the respective case support portions of the transport vehicle V, the transport apparatus H1, and the mask library LB. However, a case support member, which includes a ball transfer, etc. having a high shock resistance can be also used for the portion including the end portion of the case support portion, etc. for which it is feared that any large shock or impact might be exerted when the mask case C is delivered.

In the respective embodiments described above, the cam follower is used as the guide mechanism for the transport vehicle V, the transport apparatus H1, and the mask library LB. However, the present invention is not limited to this. It is possible to use any other mechanism capable of guiding the mask case, including a roller mechanism, etc. The cam followers are allowed to abut against the side surface portion of the mask case C to guide the mask case C in the load/unload direction. However, the cam followers may be allowed to abut against the side surface portion of the reinforcing member to guide the mask case. Further, a guide member(s), which is provided to extend in a rail-form, may be provided at a position of the mask case transport section corresponding to the reinforcing member(s) provided to extend in the rail form. The cross sectional shape of the reinforcing member may be formed complementarily with the cross sectional shape of the guide member; and the mask case may be guided in the load/unload direction by the rail-shaped guide member.

In the respective embodiments described above, the explanation has been made assuming that the transport vehicle V according to the present invention runs in the unmanned manner (self-propelled manner). However, the present invention is also applicable to a transport vehicle which is allowed to run manually by an operator or the like.

In the respective embodiments described above, the temporary fixation mechanism is provided to temporarily fix the position of the mask case C on the mask case transport section 41 by vertically moving the holding mechanism 45 provided between the ball transfers 43 arranged in the two arrays on the mask case transport section 41 of the transport vehicle V. However, the same or equivalent mechanism may be also provided on the mask case transport section 50 of the transport apparatus H1. Further, the mask case transport section 50 of the transport apparatus H1 may be provided with a temporary fixation mechanism including a holding section which is arranged under or below the mask case C and which holds the mask case, and an upward/downward movement mechanism which moves the ball transfers upwardly/downwardly.

In the respective embodiments described above, the transport vehicle V has the rotating mechanism 42, and the load/unload direction of the mask case C in relation to the transport vehicle V is allowed to coincide with the load/unload direction in relation to the transport apparatus H1. However, the transport apparatus H1 may be provided with a mechanism which rotates the load/unload direction of the mask case C in relation to the transport apparatus H1 with respect to the transport vehicle V. That is, it is appropriate that the mechanism for rotating the load/unload direction of the mask case C is provided on at least one of the transport vehicle V and the transport apparatus H1. Similarly, the mask library LB may be also provided with a mechanism which rotates the load/unload direction of the mask case C in relation to the accommodating section 65 with respect to the transport apparatus H1. Accordingly, the mutual arrangement relationship among the transport vehicle V, the transport apparatus H1, and the mask library LB (accommodating section 65) when the mask case C is delivered, can be appropriately set depending on the overall construction of the exposure apparatus, the arrangement construction of a plurality of exposure apparatuses (apparatus layout), etc.

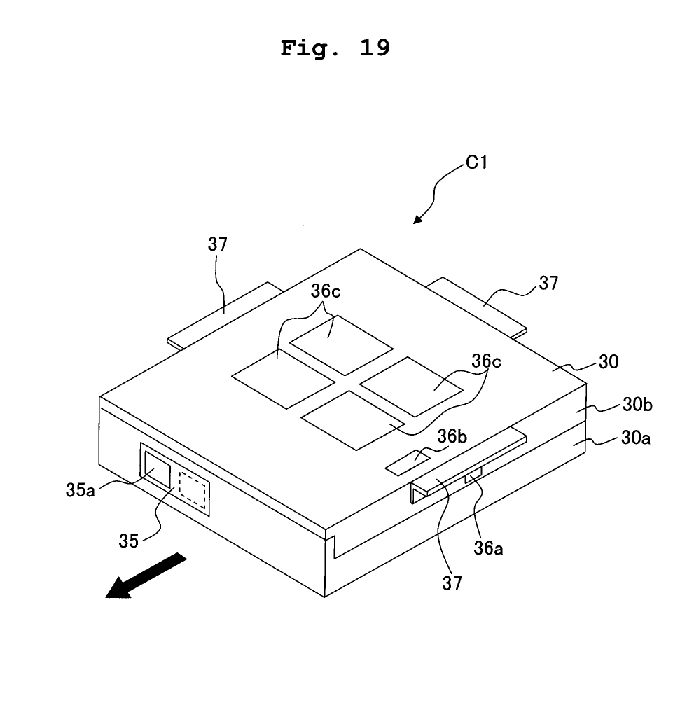

Next, an explanation will be made with reference to FIGS. 19 to 21 about an exposure apparatus according to a third embodiment of the present invention. In the exposure apparatus according to the third embodiment, the construction of a mask case to be loaded into the exposure apparatus and the construction of a mask case delivery section and a mask case transport section are different from those of the second embodiment. However, the other components or parts are constructed in the same manner as the exposure apparatus according to the second embodiment. Therefore, in the explanation of the third embodiment, the components or parts, which are the same as those of the construction of the exposure apparatus according to the second embodiment, are omitted from the detailed explanation, and the components or parts, which are the same as those of the construction of the exposure apparatus according to the second embodiment, will be explained by using the same reference numerals as those used in the second embodiment.

FIG. 19 shows a perspective view of the construction of a mask case C1. An arrow shown in FIG. 19 indicates a direction in which the mask case C1 is allowed to enter or advance, by the transport vehicle V1, into the exposure chamber CH from the load/unload port 10 of the exposure apparatus EX. As shown in FIG. 19, the mask case C1 is provided with a mask accommodating section (accommodating section body) 30 in which the mask M is accommodated, and a reinforcing member (not shown) which is provided at a contact portion with respect to the transport apparatus H1, the transport vehicle V1, etc. on which the mask case C1 is to be placed.

The mask accommodating section 30 is provided with a lower member 30a which is rectangular as seen in a plan view and which forms a space for accommodating the mask M therein, and an upper member 30b which is rectangular as seen in a plan view. The lower member 30a, the upper member 30b, and the reinforcing member are constructed substantially in the same manner as the mask case C of the embodiment described above.

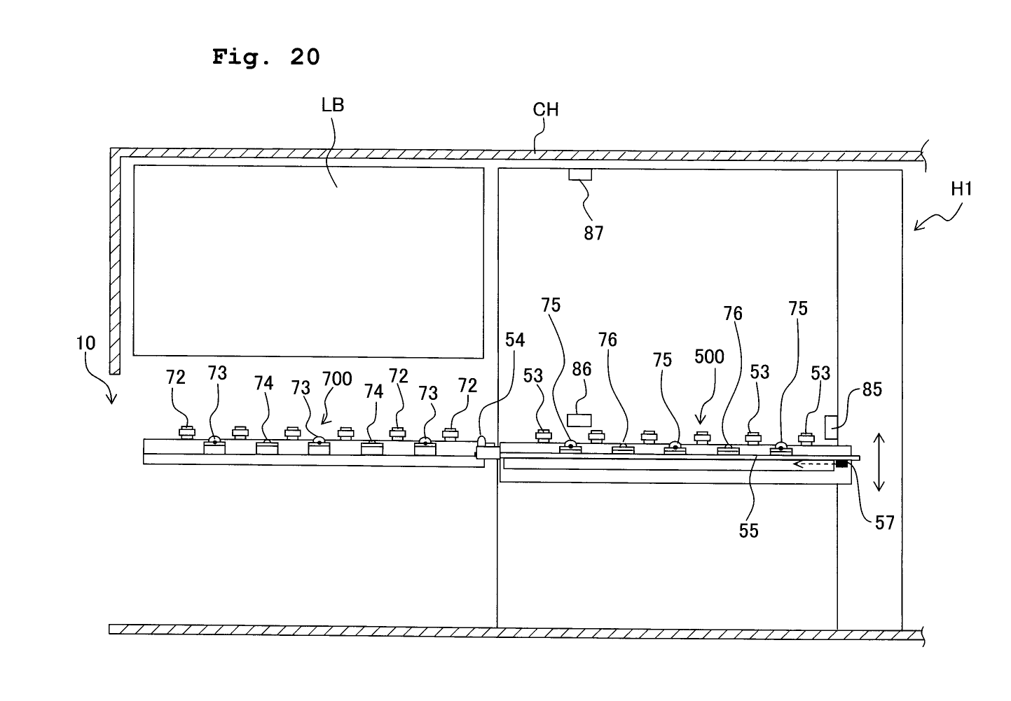

A reflecting plate attachment portion 35 is provided on the front end surface of the mask case C1 directed in the advance direction. The size of the mask M accommodated in the mask case C1 is detected, by detecting the attachment position of a reflecting plate 35a on the reflecting plate attachment portion 35 with a mask size identification sensor 85 (see FIG. 20) as described later on. Mask presence/absence sensor windows 36a, which are used when it is detected whether or not the mask M is accommodated in the mask case C1 by a mask presence/absence sensor 86 (see FIG. 20), are provided on the both side surfaces of the mask case C1. Each of the mask presence/absence sensor windows 36a, which is provided on one of the both side surfaces of the mask case C1, is formed of a transparent resin, etc., and is arranged at a position shifted or deviated by a predetermined amount in the advance direction of the mask case C1. A bar code window 36b, which is provided to read a bar code formed on the mask M accommodated in the mask case C1 by a bar code reader 87 (see FIG. 20) as described later on, is formed on the upper member 30b of the mask case C1. Mask confirmation windows 36c, which are provided to visually view or confirm the mask M accommodated in the mask case C1, are also formed on the upper member 30b of the mask case C1. Each of the bar code window 36b and the mask confirmation window 36c is formed of a transparent resin, etc. Further, lid opening/closing protrusions 37, which are used when the upper member 30b is opened/closed, are provided at both side portions and a rear end portion of the upper member 30b.

The mask M is supported in the mask case C1 by four support portions (not shown). The four support portions are provided at each of both side portions of the lower member 30a in the advance direction of the mask case C1. One of the support portions is provided at the position corresponding to the bar code window 36b provided on the upper member 30b of the mask case C1. In this case, a clearance is formed for the portion of the upper surface of the support portion at which the bar code is positioned so that the bar code, which is formed on the lower surface of the mask M, does not make any direct contact with the support portion, in relation to the support portion provided at the position corresponding to the bar code window 36b. The lower surface of the mask M is supported at both end portions of the clearance. The other seven support portions support the lower surface of the mask M by the entire upper surfaces of the support portions.

FIG. 20 shows the construction of a mask case delivery section 700 which is provided under or below the mask library LB of the exposure apparatus EX and a mask case transport section 500 which is provided on the right side of the mask case delivery section 700 in the drawing. The mask case delivery section 700 is provided with a mechanism which holds the mask case C1 and which delivers the mask case C1 with respect to the transport apparatus H1. That is, the mask case delivery section 700 is provided with a plurality of cam followers 73 which are arranged in substantially parallel two arrays and which function as case support portions for supporting the reinforcing members of the mask case C1 and suppressing the friction to be generated with respect to the reinforcing members. In this case, the cam followers 73 are constructed to be rotatable in only the advance direction of the mask case C1. Further, air floating type ball transfers 74 are provided between the cam followers 73. The air floating type ball transfers 74 are allowed to float to hold the mask case C1 when the alignment is performed in the direction perpendicular to the advance direction of the mask case C1 so that the mask case C1 is moved in the direction perpendicular to the advance direction by an unillustrated actuator to perform the alignment in the direction perpendicular to the advance direction. In FIG. 20, the cam followers 73 and the air floating type ball transfers 74 are provided alternately. However, it is also appropriate that a plurality of pieces of the cam follower 73 are provided between the air floating type ball transfers 74.

A plurality of cam followers 72, which function as a guide mechanism, are arranged in two arrays substantially parallel to the arrays of the cam followers 73 at side end portions of the mask case delivery section 700 along the cam followers 73 arranged in the two arrays. At least one array of the two arrays of the cam followers 72 is allowed to abut against the side surface portion of the mask case C1 to define the load/unload direction of the mask case C1 with respect to the mask case delivery section 700. FIG. 20 shows only the array of the cam followers 73 and the array of the cam followers 72 positioned on the back side (far side) in the drawing, of the cam followers 73 and the cam followers 72 provided in the two arrays respectively.

The mask case transport section 500 is provided with a mechanism which holds the mask case C1 and which delivers the mask case C1 between the transport vehicle V1 and the mask library LB. Specifically, a plurality of cam followers 75, which function as case support portions for supporting the reinforcing members of the mask case C1 and suppressing the friction to be generated with respect to the reinforcing members, are arranged in two substantially parallel arrays on the mask case transport section 500. In this case, the cam followers 75 are constructed to be rotatable in only the advance direction of the mask case C1. Air floating type ball transfers 76 are provided between the cam followers 75. The air floating type ball transfers 76 are allowed to float to hold the mask case C1 when the alignment is performed in the direction perpendicular to the advance direction of the mask case C1 so that the mask case C1 is moved in the direction perpendicular to the advance direction by an unillustrated actuator to perform the alignment in the direction perpendicular to the advance direction. In FIG. 20, the cam followers 75 and the air floating type ball transfers 76 are provided alternately. However, it is also appropriate that a plurality of pieces of the cam follower 75 are provided between the air floating type ball transfers 76.

A plurality of cam followers 53, which function as a guide mechanism, are arranged in two arrays substantially parallel to the arrays of the cam followers 75 at side end portions of the mask case transport section 500 along the cam followers 75 arranged in the two arrays. At least one array of the two arrays of the cam followers 53 are allowed to abut against the side surface portion of the mask case C1 to define the load/unload direction of the mask case C1 with respect to the mask case transport section 500. FIG. 20 shows only the array of the cam followers 75 and the array of the cam followers 53 positioned on the back side (far side) in the drawing, of the cam followers 75 and the cam followers 53 provided in the two arrays respectively. A slide mechanism 55, which slidably moves the mask case C1 in the load/unload direction with respect to the cam followers 75, is provided between the cam followers 75 arranged in the two arrays on the mask case transport section 500.

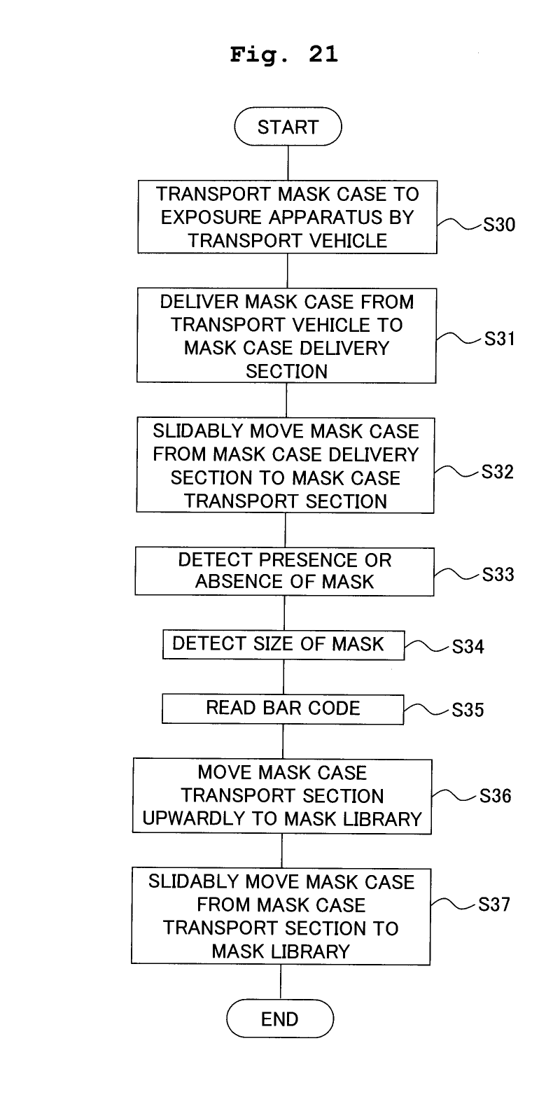

A flow chart shown in FIG. 21 illustrates the transport of the mask case C1 to the mask library LB of the exposure apparatus EX according to the third embodiment. At first, the mask case C1, in which the mask M is accommodated, is transported to the exposure apparatus EX by the transport vehicle V1 (Step S30). The mask case C1 is placed on the cam followers 73 provided on the mask case delivery section 700, and the mask case C1 is delivered to the mask case delivery section 700 (Step S31). At this point in time, the air floating type ball transfers 74 are not allowed to float, and the tops thereof are not brought in contact with the lower surface of the mask case C1.

Subsequently, the mask case C1 is slidably moved from the mask case delivery section 700 onto the mask case transport section 500 of the transport apparatus H1 (Step S32). That is, the controller CONT moves the mask case transport section 500 to a height (first transport height) corresponding to the mask case delivery section 700 by the lifting driving section 51 so that the height of the tops of the cam followers 73 of the mask case delivery section 700 is made to be coincident with the height of the tops of the cam followers 75 of the mask case transport section 500. The controller CONT slidably moves the mask case C1 from the position on the cam followers 73 of the mask case delivery section 700 to the position on the cam followers 75 of the mask case transport section 500 by the slide mechanism 55. In a case that the alignment is performed in the direction perpendicular to the advance direction of the mask case C1 in the mask case delivery section 700 and the mask case transport section 500, then the air floating type ball transfers 74, 76 are allowed to float to holds the mask case C1 with the tops thereof, and the mask case C1 is moved in the direction perpendicular to the advance direction by an unillustrated actuator to perform the alignment in the direction perpendicular to the advance direction.

Subsequently, when the mask case C1 is moved to the mask case transport section 500, the controller CONT detects whether or not the mask M is accommodated in the mask case C1 by the mask presence sensor 86 (Step S33). That is, a detecting light (detecting light beam) comes from the mask presence sensor 86 into the mask presence sensor window 36a formed on one side surface of the mask case C1, the incident detecting light comes into the mask M from a side surface of the mask M, and the light (light beam) exits from the other side surface of the mask M. The detecting light exits from the mask presence sensor window 36a formed on the other side surface of the mask case C1. Whether or not the mask M is accommodated in the mask case C1 is detected depending on whether or not the detecting light, which is reflected by an unillustrated reflecting plate, can be detected by the mask presence sensor 86.

Subsequently, the size of the mask M accommodated in the mask case C1 is detected based on the attachment position of the reflecting plate 35a at the reflecting plate attachment portion 35 detected by the mask size identification sensor 85 (Step S34).

Subsequently, the controller CONT moves the mask case transport section 500 to the uppermost portion of the transport apparatus H1 by the lifting driving section 51, and the bar code, which is formed on the mask M accommodated in the mask case C1, is read via the bar code window 36b by the bar code reader 87 (Step S35). The mask case C1 is transported from the uppermost portion of the transport apparatus H1 to the mask library LB (Steps S36, S37). This process is performed in the same manner as in Steps S12 and S13 in the first embodiment.

In a case that the mask M is transported from the mask library LB to the exposure section S, the mask case C1 is slidably moved onto the mask case transport section 500 in such a state that the upper member 30b of the mask case C1 is allowed to remain in the accommodating section 65 of the mask library LB, and the mask M is placed on the lower member 30a of the mask case C1. The lifting driving section 51 upwardly moves the mask case transport section 500 to the position CA1 (see FIG. 1) which is located at the uppermost portion of the transport apparatus H1; and the mask M is delivered to the carrier 21 at the position CA1. In this procedure, the lower member 30a, on which the mask M is placed, is moved onto the mask case transport section 500 in such a state that the lower surfaces of the lid opening/closing protrusions 37 are supported by a lid lifting mechanism (not shown) provided in the accommodating section 65 and the upper member 30b is moved upwardly in the accommodating section 65 of the mask library LB.

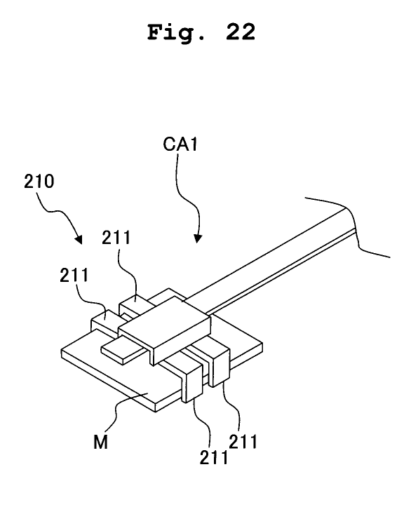

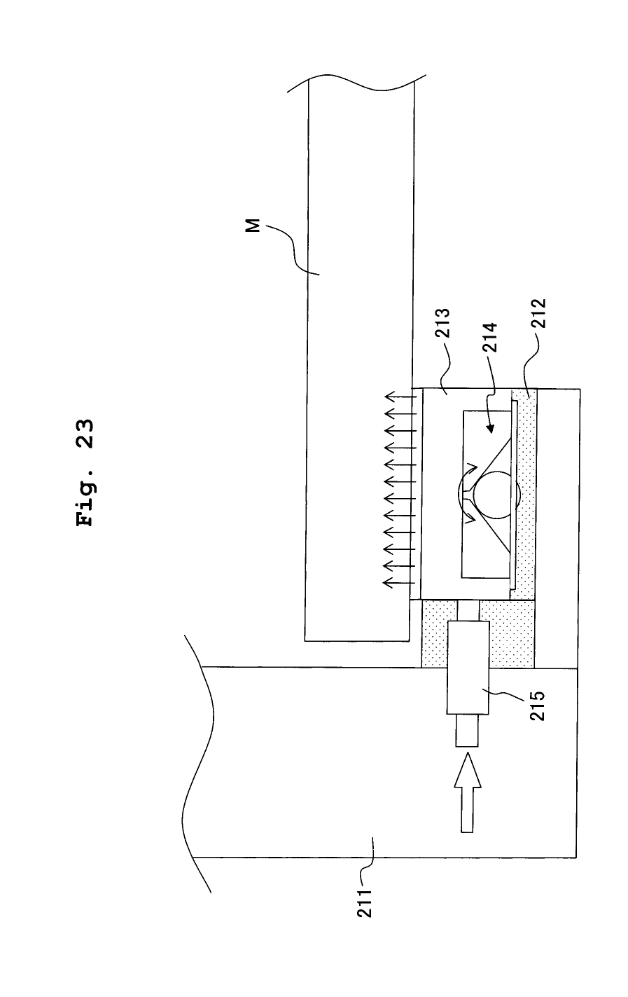

In the embodiment described above, the mask M is moved by the carrier 21 from the position CA1 to the position CA2. However, the mask M may be moved by a carrier 210 shown in FIGS. 22 and 23. As shown in FIG. 22, the carrier 210 is provided with four pawl grips (hand pawls) 211 for holding portions of the mask M disposed in the vicinity of the four corners. As shown in FIG. 23, each of the pawl grips 211 is provided with a porous air pad 213 with an intervening buffer member 212. The porous air pad 213 has a plurality of air-jetting holes entirely formed on a support surface which makes contact with the mask M. A pivot mechanism 214 is provided under or below the porous air pad 213. In a case that the mask M is warped, etc., the pivot mechanism 214 is operated in accordance with the warpage of the mask M, and the support surface of the porous air pad 213 is inclined in accordance with the warpage of the mask M. According to the pawl grip 211, air which is supplied from an air supply section 215 can be uniformly jetted against the mask M from the entire surface of the porous air pad 213. Therefore, the mask M can be allowed to flow reliably to perform the alignment for the place for placing the mask M with ease.

In the respective embodiments described above, the exposure apparatus EX, to which the present invention is applicable, includes a scanning type exposure apparatus of the step-and-scan system in which the pattern of the mask M is subjected to the scanning exposure while synchronously moving the mask M and the photosensitive substrate P, and a projection exposure apparatus of the step-and-repeat system (stepper) in which the pattern of the mask M is subjected to the exposure in a state that the mask M and the photosensitive substrate P are allowed to stand still, and the photosensitive substrate P is successively step-moved. As for the type of the exposure apparatus EX, the present invention is not limited to the exposure apparatus for producing the liquid crystal display device in which the photosensitive substrate P is exposed with the liquid crystal display device pattern. The present invention is also widely applicable, for example, to an exposure apparatus for producing a semiconductor device in which a wafer is exposed with a semiconductor device pattern, and to an exposure apparatus for producing a thin film magnetic head, an image pickup device or element (CCD), a reticle, etc. Those usable as the light source of the exposure light EL include the emission lines emitted from an ultra-high voltage mercury lamp (g-ray (436 nm), h-ray (404.7 nm), i-ray (365 nm)), the KrF excimer laser (248 nm), the ArF excimer laser (193 nm), and the F₂ laser (157 nm). Further, the magnification of the projection optical system PL is not limited to the 1× magnification system; and it is also allowable to use any one of the reducing system and the magnifying system. As for the projection optical system PL, in a case that the far ultraviolet light such as the excimer laser is used, any material such as silica glass or calcium fluoride, through which the far ultraviolet light is transmitted, is used as the material therefor. In a case that the F₂ laser or the X-ray is used, an optical system of the cata-dioptric system or the dioptric system is used. The present invention is also applicable to a proximity exposure apparatus in which the pattern of the mask M is subjected to the exposure while allowing the mask M and the photosensitive substrate P to be in tight contact with each other, without using the projection optical system PL.

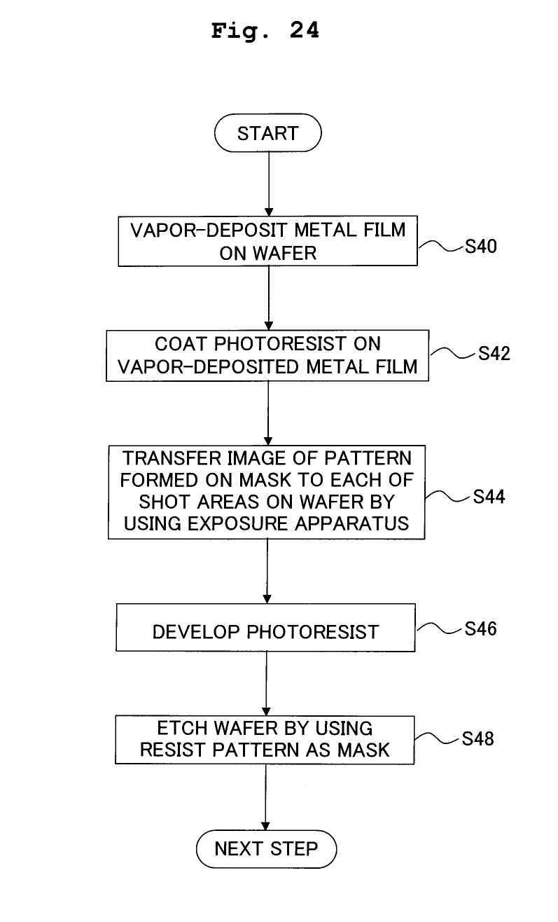

Next, an explanation will be made about a device production method using the exposure apparatus according to the present invention. FIG. 24 shows a flow chart illustrating steps of producing a semiconductor device. As shown in FIG. 24, in the steps of producing the semiconductor device, a metal film is vapor-deposited on a wafer which serves as a substrate of the semiconductor device (Step S40), and a photoresist as a photosensitive material is coated on the vapor-deposited metal film (Step S42). Subsequently, the mask (reticle) is taken out from the mask library in the exposure apparatus according to the present invention, and the mask (reticle) is transported onto the mask stage (transport step). A projected image of a pattern provided on the mask is transferred to each of shot areas on the wafer (Step S44: exposure step (illuminating step and projection step). The wafer for which the transfer has been completed is developed, i.e., the photoresist, to which the projected image of the pattern has been transferred, is developed (Step S46: development step). After that, the resist pattern, which is formed on the wafer in accordance with Step S46, is used as a mask to perform processing including, for example, etching with respect to the wafer (Step S48: processing step).

The term “resist pattern” herein refers to the photoresist layer formed with protrusions and recesses having shapes corresponding to the projected image of the pattern transferred by the exposure apparatus according to the present invention, wherein the recesses penetrate through the photoresist layer. In Step S48, the wafer surface is processed via the resist pattern. The processing, which is performed in Step S48, includes, for example, at least one of the etching of the wafer surface and the film formation of a metal film or the like. In Step S44, the exposure apparatus according to the present invention transfers the pattern by using, as the photosensitive substrate, the wafer coated with the photoresist.

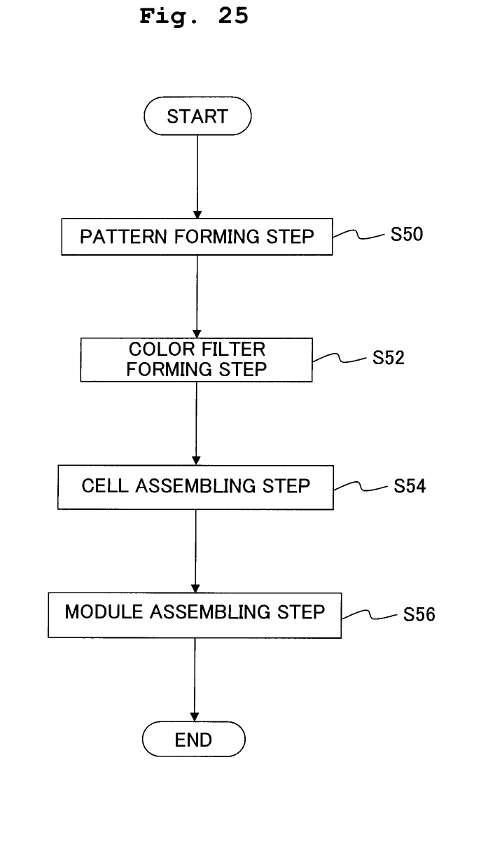

FIG. 25 shows a flow chart illustrating steps of producing a liquid crystal device such as a liquid crystal display element or the like. As shown in FIG. 25, those successively performed in the steps of producing the liquid crystal device include a pattern forming step (Step S50), a color filter forming step (Step S52), a cell assembling step (Step S54), and a module assembling step (Step S56).

In the pattern forming step of Step S50, a predetermined pattern, which includes, for example, a circuit pattern and an electrode pattern, is formed by using the exposure apparatus according to the present invention on a glass substrate which is coated with a photoresist as the photosensitive substrate. The pattern forming step includes the exposure step of transferring a projected image of the pattern provided on the mask to the photoresist layer by using the exposure apparatus according to the present invention; a developing step of developing the photosensitive substrate transferred with the projected image of the pattern, i.e., developing the photoresist layer on the glass substrate to form the photoresist layer having the shape corresponding to the projected image of the pattern; and a processing step of processing the glass substrate via the developed photoresist layer. In the color filter forming step of Step S52, a color filter is formed, in which a large number of sets of three types of dots corresponding to R (Red), G (Green), and B (Blue) are arranged in a matrix form, or a plurality of sets of filters of three types of stripes of R, G, and B are arranged in the horizontal scanning direction.

In the cell assembling step of Step S54, the liquid crystal panel (liquid crystal cell) is assembled by using the glass substrate on which the predetermined pattern has been formed in accordance with Step S50 and the color filter which has been formed in accordance with Step S52. Specifically, for example, the liquid crystal is injected into a space between the glass substrate and the color filter, and thus the liquid crystal panel is formed. In the module assembling step of Step S56, various parts, which include, for example, an electric circuit and a backlight performing the display operation of the liquid crystal panel, are attached to the liquid crystal panel having been assembled in accordance with Step S54.

The present disclosure relates to the theme or the subject included in Japanese Patent Application No. 2007-296640 filed on Nov. 15, 2007, the entire disclosure of which is evidently incorporated herein by reference.

What is claimed is:

1. A mask case which accommodates a mask therein, the mask case comprising
a reinforcing member which has a strength corresponding to a load of the mask and which is provided at a contact portion contacting with an external apparatus on which the mask case is placed.

2. The mask case according to claim 1, wherein the reinforcing member is provided to extend in a rail form in a load/unload direction of the mask case with respect to the external apparatus.

3. The mask case according to claim 2, wherein the reinforcing member has a flat surface portion which makes contact with the external apparatus, the flat surface portion having a width of not less than a predetermined width with respect to the load/unload direction.

4. The mask case according to claim 2, wherein the reinforcing member has a tapered surface which is inclined with respect to a direction of the load of the mask and which is provided in the reinforcing member at a position of at least one end portion in the load/unload direction.

5. The mask case according to claim 1, wherein the reinforcing member is formed by using a hardened metal member.

6. The mask case according to claim 1, wherein the reinforcing member has a specific gravity which is larger than that of a constitutive material used for an accommodating section body in which the mask is accommodated.

7. The mask case according to claim 1, wherein the reinforcing member is provided on a bottom surface portion of the mask case.

8. The mask case according to claim 1, further comprising a connecting portion disconnectively connectable to a slide mechanism which slidably moves the mask case with respect to the external apparatus.

9. A transport apparatus which transports a mask, the transport apparatus comprising a case support portion supporting the reinforcing member of the mask case as defined in claim 1, in which the mask is accommodated, and suppressing friction which is generated with respect to the reinforcing member.

10. The transport apparatus according to claim 9, wherein the case support portion is provided in a load/unload direction of the mask case with respect to the transport apparatus; and the case support portion supports the reinforcing member in the load/unload direction.

11. The transport apparatus according to claim 9, further comprising a guide mechanism which guides the mask case in a load/unload direction of the mask case with respect to the transport apparatus.

12. The transport apparatus according to claim 9, further comprising a temporary fixation mechanism which temporarily fixes a position of the mask case.

13. The transport apparatus according to claim 12, wherein the temporary fixation mechanism includes a holding mechanism which holds the mask case and which moves the mask case upwardly/downwardly with respect to the case support portion.

14. The transport apparatus according to claim 12, wherein the temporary fixation mechanism includes an upward/downward movement mechanism which moves the mask case upwardly/downwardly together with the case support portion, and a holding portion which holds the mask case moved downwardly by the upward/downward movement mechanism.

15. The transport apparatus according to claim 11, further comprising a temporary fixation mechanism which pushes the mask case to make the mask case abut against the guide mechanism and to temporarily fix a position of the mask case.

16. The transport apparatus according to claim 9, further comprising a rotating mechanism which rotates the case support portion to change a load/unload direction of the mask case with respect to the transport apparatus.

17. The transport apparatus according to claim 16, further comprising an angle detector which detects angle information corresponding to an angle of rotation of the case support portion brought about by the rotating mechanism;
wherein the rotating mechanism rotates the case support portion based on the angle information.

18. The transport apparatus according to claim 9, further comprising a slide mechanism which slidably moves the mask case with respect to the case support portion in a load/unload direction of the mask case with respect to the transport apparatus.

19. The transport apparatus according to claim 9, further comprising an apparatus movement mechanism which moves the transport apparatus.

20. The transport apparatus according to claim 18, further comprising:
a lifting movement mechanism which holds the case support portion and which vertically moves the case support portion with respect to a first transport height corresponding to a load/unload port for the mask case and a second transport height corresponding to a storage section for the mask case provided over or above the load/unload port; and
a delivery control section which drives the slide mechanism when the case support portion is moved to the first transport height or the second transport height and which delivers the mask case with respect to the storage section or a transport vehicle arranged in the vicinity of the load/unload port.

21. The transport apparatus according to claim 18, further comprising:
a delivery section which is provided for delivery of the mask case;
a storage section which is provided over or above the delivery section and which stores the mask case;
a lifting movement mechanism which holds the case support portion and which vertically moves the case support portion with respect to a first transport height corresponding to the delivery section and a second transport height corresponding to the storage section; and
a delivery control section which drives the slide mechanism when the case support portion is moved to the first transport height or the second transport height and which delivers the mask case with respect to the delivery section or the storage section.

22. The transport apparatus according to claim 20, wherein the storage section has the case support portion;
the lifting movement mechanism makes a height of the case support portion of the lifting movement mechanism at the second transport height to be coincident with a height of the case support portion of the storage section; and
the slide mechanism slidably moves the mask case between the case support portion of the lifting movement mechanism and the case support portion of the storage section.

23. The transport apparatus according to claim 21, wherein the storage section has the case support portion;
the lifting movement mechanism makes a height of the case support portion of the lifting movement mechanism at the second transport height to be coincident with a height of the case support portion of the storage section; and
the slide mechanism slidably moves the mask case between the case support portion of the lifting movement mechanism and the case support portion of the storage section.

24. The transport apparatus according to claim 20, wherein the transport vehicle has the case support portion;
the lifting movement mechanism makes a height of the case support portion of the lifting movement mechanism at the first transport height to be coincident with a height of the case support portion of the transport vehicle; and
the slide mechanism slidably moves the mask case between the case support portion of the lifting movement mechanism and the case support portion of the transport vehicle.

25. The transport apparatus according to claim 21, wherein the delivery section has the case support portion;
the lifting movement mechanism makes a height of the case support portion of the lifting movement mechanism at the first transport height to be coincident with a height of the case support portion of the delivery section; and
the slide mechanism slidably moves the mask case between the case support portion of the lifting movement mechanism and the case support portion of the delivery section.

26. The transport apparatus according to claim 25, wherein the delivery section delivers the mask case with respect to a delivery holding mechanism which moves the mask case upwardly/downwardly with respect to the case support portion of the delivery section.

27. An exposure apparatus comprising:
the transport apparatus as defined in claim 20; and
a projection optical system which forms, on a photosensitive substrate, a projected image of a pattern provided on a mask transported by using the transport apparatus.

28. An exposure apparatus comprising:
the transport apparatus as defined in claim 21; and
a projection optical system which forms, on a photosensitive substrate, a projected image of a pattern provided on a mask transported by using the transport apparatus.

29. A mask transport method comprising:
transporting a mask accommodated in a mask case to a second transport apparatus as defined in claim 24 by a first transport apparatus including an apparatus movement mechanism and a case support portion supporting a reinforcing member provided on the mask case and suppressing friction which is generated with respect to the reinforcing member;
slidably moving the mask case from a position on the case support portion of the first transport apparatus to a position on the case support portion of the lifting movement mechanism provided on the second transport apparatus;
upwardly moving the case support portion of the lifting movement mechanism to a height of the storage section having the case support portion; and
slidably moving the mask case from the position on the case support portion of the lifting movement mechanism to a position on the case support portion of the storage section.

30. A mask transport method comprising:
transporting a mask accommodated in a mask case to the transport apparatus as defined in claim 25 by a transport vehicle;
delivering the mask case from the transport vehicle to a position on the case support portion of the delivery section provided on the transport apparatus;
slidably moving the mask case from the position on the case support portion of the delivery section to a position on the case support portion of the lifting movement mechanism provided on the transport apparatus;
upwardly moving the case support portion of the lifting movement mechanism to a height of the storage section having the case support portion; and
slidably moving the mask case from the position on the case support portion of the lifting movement mechanism to a position on the case support portion of the storage section.

31. A device production method comprising:
performing exposure by transferring a projected image of a pattern provided on a mask to a photosensitive substrate by using the exposure apparatus as defined in claim 27;
developing the photosensitive substrate to which the projected image has been transferred to form a mask layer having a shape corresponding to the projected image on the photosensitive substrate; and
processing the photosensitive substrate via the mask layer.

32. A device production method comprising:
performing exposure by transferring a projected image of a pattern provided on a mask which is transported by the mask transport method as defined in claim 29, to a photosensitive substrate;
developing the photosensitive substrate to which the projected image has been transferred to form a mask layer having a shape corresponding to the projected image on the photosensitive substrate; and
processing the photosensitive substrate via the mask layer.

33. A device production method comprising:
performing exposure by transferring a projected image of a pattern provided on a mask which is transported by the mask transport method as defined in claim 30, to a photosensitive substrate;
developing the photosensitive substrate to which the projected image has been transferred to form a mask layer having a shape corresponding to the projected image on the photosensitive substrate; and
processing the photosensitive substrate via the mask layer.
